(19) United States
(12) Patent Application Publication
(10) Pub. No.: US 2025/0309943 A1
(43) Pub. Date: Oct. 2, 2025

(54) RADIO FREQUENCY IDENTIFICATION TAGS FOR A RECONFIGURABLE INTELLIGENT SURFACE

(71) Applicant: QUALCOMM Incorporated, San Diego, CA (US)

(72) Inventors: Ahmed ELSHAFIE, San Diego, CA (US); Huilin XU, Temecula, CA (US); Yu ZHANG, San Diego, CA (US); Zhikun WU, Beijing (CN); Hung Dinh LY, San Diego, CA (US); Yuchul KIM, San Diego, CA (US); Linhai HE, San Diego, CA (US); Seyedkianoush HOSSEINI, San Diego, CA (US)

(21) Appl. No.: 18/866,635

(22) PCT Filed: Aug. 4, 2022
(86) PCT No.: PCT/CN2022/110156

§ 371 Date: Nov. 18, 2024

(51) Int. Cl. H04B 7/04; G06K 7/10; H04L 25/02

(52) U.S. Cl. CPC H04B 7/04013; G06K 7/10366; H04L 25/0202

(57) ABSTRACT

A reconfigurable intelligent surface (RIS) includes one or more radio frequency identification (RFID) tags. The one or more RFID tags may perform functions of a controller of the RIS. The one or more RFID tags receive a reference signal from a wireless communications device. The RIS may process the received reference signal and the one or more RFID tags backscatter a response signal to the wireless communications device. The wireless communications device may also perform processing of the backscattered response. Processing includes measuring channels from the wireless communication to the RFID tags. Processing also includes estimating channels from the wireless communication to elements of the RIS. Based on the estimated channels, a beam matrix corresponding to optimized weights of the RIS elements is determined and transmitted to the RIS.

### TECHNICAL FIELD

The present disclosure is directed to wireless communication systems and methods and more particularly to devices, systems, and methods for implementing RFID tags within RIS devices and increasing training efficiency of RIS devices using RFID tags for channel measurement and estimation.

### INTRODUCTION

Wireless communications systems are widely deployed to provide various types of communication content such as voice, video, packet data, messaging, broadcast, and so on. These systems may be capable of communication with various devices using, for example, reflective surfaces, such as reconfigurable intelligent surfaces (RISs). A wireless communications system may include a number of base stations (BSs), each simultaneously supporting communications for multiple communication devices, which may be otherwise known as user equipment (UE). A wireless communications system may additionally a number of RISs.

A RIS may extend the range of a wireless communications device by reflecting signals in various directions to other wireless communications devices around obstructions which may otherwise limit a device's range. For example, A RIS surface includes multiple RIS elements configurable by corresponding RIS element weights. A set of weights of the RIS elements may be determined and adopted to optimize communication, which typically involves training for the RIS elements. Existing training methods for RIS devices include sequentially modifying the RIS element weights as one wireless communications device sends reference signals to the other wireless communications device until the ideal RIS element weights are identified. A RIS device typically include a controller and antenna requiring a dedicate power source.

In some instances, the use or RIS devices is not adopted due to constraints imposed by power requirements of the devices. In addition, training of RIS devices is inefficient, requiring processing power and time on the part of the RIS controller and any participating wireless communications devices. Therefore, there exists a need for improved methods of training RIS devices and decreasing power consumption of RIS devices.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to one aspect of the present disclosure, a method of wireless communication includes: receiving a first signal by a first wireless communications device from a second wireless communications device, the first wireless communications device further comprising: a reconfigurable intelligent surface (RIS) including an array of one or more RIS elements; a RIS controller; and a radio frequency identification (RFID) tag, the first signal being received by the RFID tag; and conveying, by the RFID tag of the first wireless communications device to the second wireless communications device, a second signal using backscatter communication based on the first signal.

According to another aspect of the present disclosure, a method of wireless communication includes: transmitting a first signal by a first wireless communications device to a second wireless communications device, the second wireless communications device comprising: a reconfigurable intelligent surface (RIS) including an array of one or more RIS elements; a RIS controller; and a radio frequency identification (RFID) tag, the first signal being received by the RFID tag; and receiving, by the first wireless communications device from the second wireless communications device using backscatter communication, a second signal based on the first signal.

According to another aspect of the present disclosure, a wireless communications device includes a reconfigurable intelligent surface (RIS) including an array of one or more RIS elements; a RIS controller; a radio frequency identification (RFID) tag, the first signal being received by the RFID tag; and a processor, wherein the wireless communications device is configured to: receive, by the RFID tag, a first signal; and convey, by the RFID tag, a second signal using backscatter communication based on the first signal.

According to another aspect of the present disclosure, a wireless communications device includes: a transceiver; and a processor coupled with the transceiver, wherein the wireless communications device is configured to: transmit a first signal to a reconfigurable intelligent surface (RIS), the RIS comprising: an array of one or more RIS elements; a RIS controller; and a radio frequency identification (RFID) tag, the first signal being received by the RFID tag; and receive from the RIS, a second signal based on the first signal.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates a channel estimation and communication scenario involving a BS, a UE, and a RIS, according to some aspects of the present disclosure.

FIG. 3 is a block diagram of an exemplary UE, according to some aspects of the present disclosure.

FIG. 4 is a block diagram of an exemplary BS, according to some aspects of the present disclosure.

FIG. 5 is a block diagram of an exemplary RIS, according to some aspects of the present disclosure.

FIG. 6A illustrates a diagrammatic view of a RIS with an RFID tag controller, according to some aspects of the present disclosure.

FIG. 6B illustrates a diagrammatic view of a RIS with RFID tags, according to some aspects of the present disclosure.

FIG. 7 illustrates a simplified diagram of an energy charging scheme according to some aspects of the present disclosure.

FIG. 8 is a diagrammatic view of channel estimation for individual RIS elements, according to aspects of the present disclosure.

FIG. 9 is a signaling diagram of communication between a BS, a RIS, and a UE, according to aspects of the present disclosure.

FIG. 10 is a signaling diagram of communication between a BS, a RIS, and a UE, according to aspects of the present disclosure.

FIG. 11 is a flow diagram of a wireless communication method, according to some aspects of the present disclosure.

FIG. 12 is a flow diagram of a wireless communication method according to some aspects of the present disclosure.

FIG. 13 is a diagram illustrating an example disaggregated BS architecture, according to some aspects of the present disclosure.

FIG. 14 illustrates a diagram of a system including a device that supports RU sharing techniques in wireless communications according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

5G NR provides increased reliability and ubiquity of wireless data transmission. To better facilitate increased coverage of wireless data transmission, reconfigurable intelligent surfaces (RISs) are used. In communication scenarios in which a wireless communication device (such as a UE) is separated from another wireless communication device (such as a BS) by an obstruction, wireless communication between the devices may be degraded, inhibited, or impossible. A RIS may be positioned relative to the obstruction and the communicating wireless communications device such that signals from one device to the other may reflect off the RIS surface and around the obstruction. In this way, wireless coverage of either wireless communications device is improved.

A RIS surface may include multiple RIS elements. Each RIS element may be configured with a RIS element weight. Different RIS element weights may alter a reflected wireless signal. For example, RIS elements may direct the signal in different directions by beam steering, adjust a frequency or time delay of the signal, invert the signal, or otherwise modify the signal. Different RIS weights may increase the strength and reliability of the communication between the wireless communications devices. In that regard, an ideal set of weights of the RIS elements should be determined and adopted to optimize communication. Some methods of training the RIS elements include sequentially modifying the RIS element weights as one wireless communications device sends reference signals to the other wireless communications device. The wireless communications devices may determine which set of RIS element weights (a beam matrix) corresponds to the highest signal quality. This beam matrix may be transmitted to the RIS and the RIS may implement the weights of the RIS elements according to the matrix.

According to aspects of the present disclosure, a RIS may include one or more radio frequency identification (RFID) tags. RFID tags of the RIS may be used to receive or transmit signals. For example, one or more RFID tags may be included in a RIS controller as the transceiver for the RIS controller. In some aspects, the RIS controller may be one or more RFID tags. In some aspects, the beam matrix previously described may be received by a RIS by one or more RFID tags of the RIS. In some aspects, RFID tags may additionally perform various processing techniques. In that regard, an RFID tag may operate as a controller of a RIS, including performing the functions of a RIS controller, such as receiving and implementing RIS element weights of a beam matrix.

In some aspects, multiple RFID tags may be positioned on a RIS surface and be in communication with the RIS controller (which may further have its own integrated controller). For example, the RFID tags may be positioned on the RIS surface in a pattern together with the RIS elements. In such aspects, a channel between each RFID tag and one of the wireless communications devices previously mentioned may be measured, which may be used to interpolate channel information between RIS elements and the communicating device(s), such as a BS and/or UE.

For example, the RFID tags of the RIS may receive a reference signal from one of the wireless communications devices. The RFID tags may compare the received signal with an expected reference signal and determine one or more values to characterize the channel of communication respective to each RFID tag. The measured channel data may then be used (e.g., by interpolation or extrapolation) to estimate channels between the RIS elements and the wireless communications device. The RFID tags may similarly estimate channels between the RIS elements and the other wireless communications device. In some aspects, other components, such as the RIS controller or either of the wireless communications devices may measure and/or estimate channels. The controller of the RIS, RFID tags of the RIS, or either wireless communications devices may then determine a beam matrix, including optimal weights for RIS elements based on the estimated channels of the RIS elements with respect to both wireless communication devices.

Aspects of the present disclosure advantageously reduce computational and/or processing power for wireless communications devices training a RIS, or for the RIS itself. In addition, the use of RFID tags for RIS devices decreases power requirements of RIS devices, resulting in potentially passive or near-passive RIS devices. This, in turn, increases the chances of adoption of RIS devices to increase wireless coverage in many locations and reduces implementation cost and complexity. Moreover, aspects of the present disclosure enable the measuring of the channels between the RF source (e.g., BS or UE) and the RIS surface, which in turn enables the estimating of individual channels (or an indication of it) between the BS and the RIS, and between the RIS and UE, which was previously not an option.

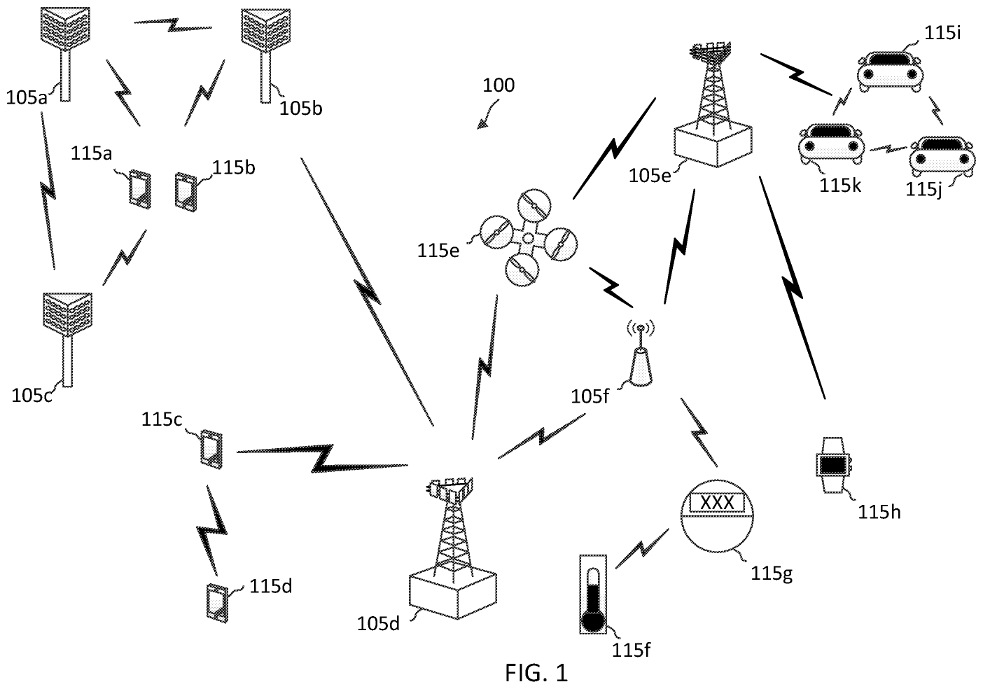

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communications device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communications devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115 (e.g., sidelink communications), and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. As further discussed with respect to the remaining figures below, sidelink UEs 115 may transmit sidelink reference signals between each other, such as for example modeled after CSI-RS, though other types are possible as well.

Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 may initiate an initial network attachment procedure with the network 100. When the UE 115 has no active data communication with the BS 105 after the network attachment, the UE 115 may return to an idle state (e.g., RRC idle mode). Alternatively, the UE 115 and the BS 105 can enter an operational state or active state, where operational data may be exchanged (e.g., RRC connected mode). For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the BS 105 may transmit a PRACH configuration to the UE 115. The PRACH configuration may indicate a set of ROs in the PRACH configuration. The BS 105 and/or the UE 115 may divide ROs into different groups, including a first group of ROs configured for PRACH repetitions, and a second group configured for single PRACH transmissions. In addition to BS-UE communication, as noted briefly above various UEs 115 may additionally, or alternatively, engage in sidelink communications with each other. And, according to embodiments of the present disclosure, the UEs thus engaged in sidelink communications may be configured for multiplexing multiple UEs' sidelink reference signals onto the same resources through the configuration and sharing of one or more sidelink reference signal parameters between the participating UEs, as will be further described with respect to the figures below.

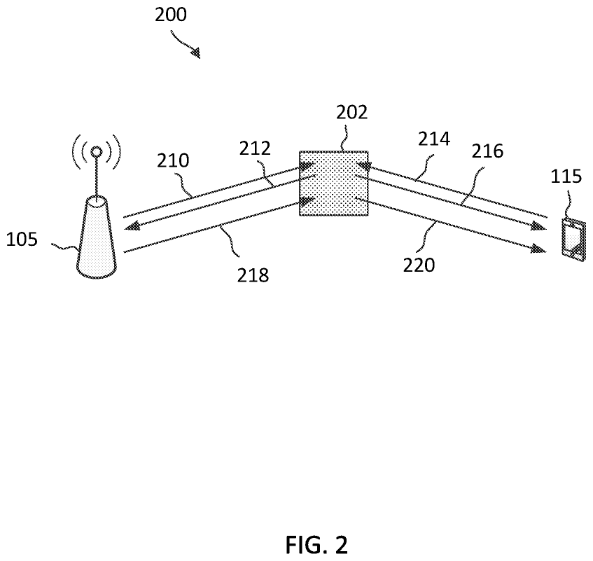

FIG. 2 illustrates a channel estimation and communication scenario 200 involving a BS, a UE, and a RIS, according to some aspects of the present disclosure. In some aspects, the BS 105 may communicate with the UE 115 by wirelessly transmitting information by radiofrequency (RF) waves of various channels or types, which are reflected by the RIS 202. In that regard, the RIS 202 may include multiple RIS elements which may be reconfigurable to correspond to different weights to steer a reflected signal from one device to another. It is noted that while the BS 105 and UE 115 are shown in FIG. 2, any suitable types of wireless communications devices may transmit and/or receive signals wirelessly via the RIS 202. For example, a UE may transmit a signal via a sidelink connection to another UE by reflecting the signal with the RIS 202. Similarly, a BS or network unit may transmit signals to another BS or network unit with the RIS 202 in a similar way.

In some aspects, RISs, such as the RIS 202 shown in FIG. 2, may also be referred to as reflectarrays, or (near-) passive MIMO arrays. A RIS 202 may include a reflective surface configured to reflect signals to and from the transmitting/receiving devices. In some aspects, the RIS 202 may include an array of reflectors configured to direct signal energy. A UE/BS 115/105 may use the RIS 202 by transmit and/or receive beamforming in a direction associated with the RIS 202. A RIS 202 may be configured with parameters which affect its reflective properties. In addition to controlling the direction of reflection, a RIS 202 may potentially shift the frequency of a reflected signal. The RIS 202 may be used to reflect the signal transmitted by the BS 105 and to be received by the UE 115. The RIS 202 may include on or more RFID tags. The one or more RFID tags of the RIS 202 may be used to transmit and/or receive signals.

In some aspects, beam training may be implemented with respect to the RIS 202 to optimize communication between the BS 105 and the UE 115, or any other wireless communications devices. A reference signal may be transmitted by the BS 105 to the UE 115. The reference signal may be reflected by the RIS 202. While the reference signal is transmitted, the RIS 202 may configure the RIS elements according to a particular set of weights, for example, corresponding to a particular beam index or beam matrix. The UE 115 may receive the reflected reference signal and analyze the received reference signal to determine the quality of the signal. In some aspects, the BS 105 may also transmit additional reference signals to the UE 115. As each reference signal is transmitted from the BS 105, the RIS 202 may adjust the weights of various RIS elements, thus altering a direction of reflection or otherwise altering aspects of the signal itself (e.g., signal modulation). The UE 115 may similarly analyze each received reference signal. In some aspects, the UE 115 may transmit various signals to the BS 105 during a beam training procedure. In this way, the UE 115 and/or the BS 105 may determine which reference signal corresponds to the best signal quality and identify the beam index or beam matrix (e.g., weights of RIS elements) which resulted in the reference signal of the highest signal quality. The BS 105 and/or UE 115 may then transmit a signal to the RIS 202 identifying the beam index or beam matrix corresponding to the highest quality signal. The RIS 202 may receive a signal indicating the selected beam index or beam matrix for communication between the BS 105 and the UE 115 by one or more RFID tags. In some aspects, the beam index or beam matrix is received by all the RFID tags of the RIS 202. In some aspects, the beam index or beam matrix is received by a set of RFID tags for better beamforming and reliability. In some aspects, the RIS 202 may transmit an acknowledgment of the received signal by backscatter communication, as will be described in more detail hereafter. The beam matrix transmitted from the BS 105 to the RIS 202 may also be referred to as a beam index. The beam matrix may include at least one parameter or setting, such as a weight value, for each RIS element of the RIS 202. The RIS 202 may configure each RIS element according to the beam matrix upon receipt.

In some aspects, the beam matrix may be determined by various channel estimation techniques for each channel between each RIS element and the BS 105 and/or the UE 115 respectively. In particular, during a beam training procedure in which multiple reference signals are transmitted from, for example, the BS 105 to the UE 115 via the RIS 202, properties of a channel from the BS 105 to one or more elements of the RIS 202 may not be known. Similarly, properties of a channel from one or more elements of the RIS 202 to the UE 115 may not be known. Rather, the transmission of a references signal from the BS 105, reflecting from the RIS 202, and received at the UE 115 is analyzed as a whole as beam indices of the RIS 202 are altered. Thus, the optimal beam matrix may be selected for the communication of BS 105 and UE 115 without determining optimal communication between the BS 105 and RIS 202 individually or between the UE 115 and RIS 202 individually. This may correspond to a configuration where the RIS 202's controller includes an RFID tag. However, the introduction of multiple RFID tags on the RIS 202 (e.g., amongst the array of RIS elements) allows the individual channels between the BS 105 and elements of the RIS 202 and/or the individual channels between the RIS 202 and the UE 115 to be estimated based on the measured properties of the channels between the BS 105 and the RFID tags, as well as with respect to the UE 115. The optimal beam matrix or weighting values of the elements of the RIS 202 may then be determined based on the individual channel estimations, thus increasing the accuracy and efficiency of beam training for the RIS 202.

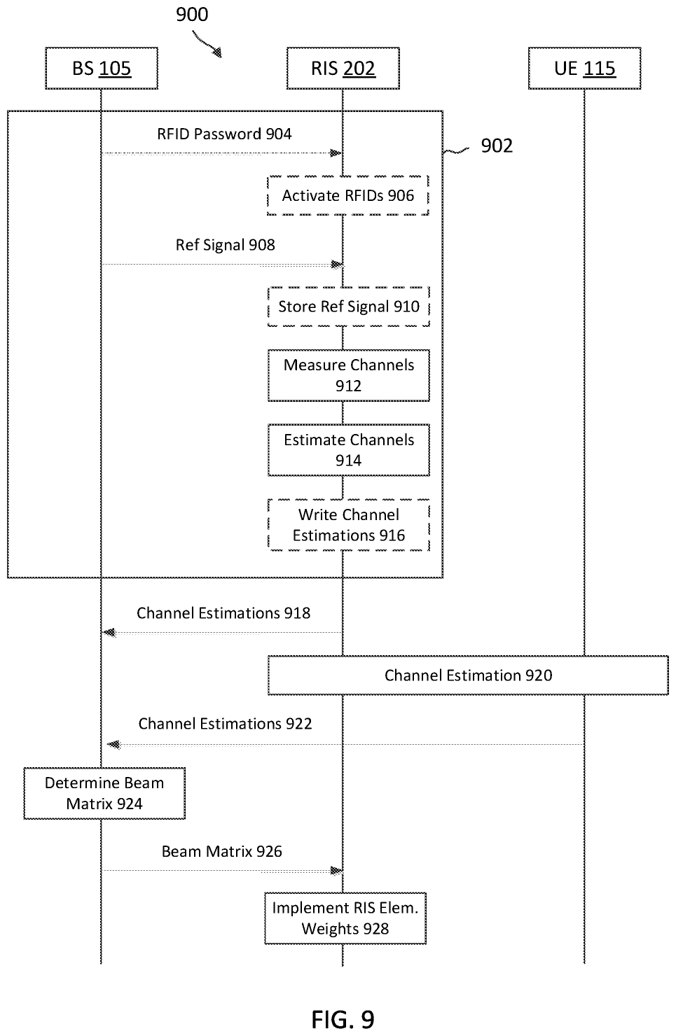

FIG. 2 illustrates a simple example for purposes of illustration. The BS 105 transmits a reference signal to the RIS 202 as shown by the transmission 210. The RIS 202 measures the channel corresponding to the reference signal received for each RFID tag of the RIS 202. As will be explained in more detail with reference to FIG. 9, the RIS 202 then estimates the channel to each RIS element of the RIS 202. This may be accomplished by interpolation or extrapolation based on the measured channels to the RFID tag. As a result, the RIS 202 may determine a matrix, G, including a channel estimation value for each RIS element of the RIS 202 with the BS 105. As will be explained hereafter, various wireless communication devices, or components or processors of various wireless communications devices may measure and/or estimate channels to determine the matrix ( ) For example, the controller of the RIS 202, RFID tags of the RIS 202, the BS 105, and/or the UE 115 may perform any of these functions. In the example shown in FIG. 2, a processor of the controller of the RIS 202 may determine matrix G based on the channel measurements and estimations. The RIS 202 may then transmit the channel estimation values within the matrix (to the BS 105, as shown by the transmission 212.

In some aspects, the estimations of channels between the UE 115 and the RIS 202 may additionally be made. For example, the UE 115 may transmit a reference signal to the RIS 202 as shown by the transmission 214. The RIS 202 may measure the channel corresponding to the reference signal received at each RFID tag of the RIS 202. The RIS 202 may then estimate the channel of each RIS element of the RIS 202 with the UE 115 in a similar manner as described above. In this way, the RIS 202 may determine a matrix, H, including a channel estimation value between each RIS element of the RIS 202 and the UE 115. The controller of the RIS 202, RFID tags of the RIS 202, the UE 115, or the BS 105 may perform any of these functions. In the example shown in FIG. 2, a processor of the controller of the RIS 202 may determine matrix H based on the channel measurements and estimations. The RIS 202 may then transmit the channel estimation values within the matrix H to the UE 115, as shown by the transmission 216. In some aspects, the channel estimation values within the matrix H may additionally or alternatively be transmitted to the BS 105. For example, the RIS 202 may transmit both matrices (and H to the BS 105 via transmission 212 and/or to the UE 115 via transmission 216.

In an aspect in which the BS 105 receives matrices G and H, the BS 105 may determine a matrix Φ including weight values for the RIS 202 elements based on the matrices G and H. In some aspects, Φ may be a diagonal matrix. Communication between the BS 105 and the UE 115 may be modeled as Equation 1: x*P*G*Φ*H*R, wherein x represents a transmitted signal, such as a reference signal, P represents a precoder of the BS 105, and R represents a filter of the UE 115. In some aspects, the BS 105 may optimize Equation 1 to determine matrix Φ. Matrix Φ may, therefore, be the same optimal beam matrix which was determined by the beam training method described above. In that regard, matrix Φ may include weighting values for each of the RIS elements of the RIS 202. In some aspects, the BS 105 may additionally determine values of matrix P and/or matrix R. In some aspects, the matrix P may correspond to a beam selection of the BS 105 and the matrix R may correspond to a beam selection of the UE 115. As described previously, any wireless communications devices may perform any of the functions described. In that regard, the matrix P may correspond to any beam steering parameter of a transmitting wireless communications device and the matrix R may correspond to any beam steering parameter of a receiving wireless communications device.

In some aspects, after determining any or all of matrices Φ, P, or R, the BS 105 may transmit the matrix Φ to the RIS 202. In response to receiving the matrix Φ, the RIS 202 may configure the RIS elements according to the weighting values of the matrix Φ. The BS 105 may then transmit a signal to the UE 115 with the RIS 202 implementing the weights of the matrix P. For example, the BS 105 may transmit a signal, such as various data or command signals, via the transmission 218. The signal may be reflected by the RIS 202 according to the weighting values of the matrix Φ, and the signal may be received by the UE 115 according to the transmission 220 shown. In similar manner the UE 115 may transmit one or more signals to the BS 105. Additional aspects of beam training, channel estimation, and signal transmission between wireless communications devices with a RIS including one or more RFID tags will be described in more detail with reference to the following figures.

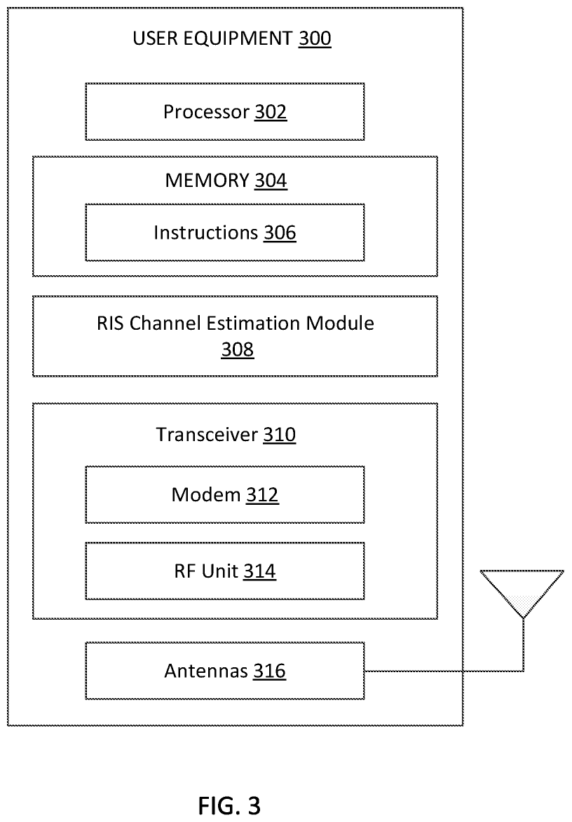

FIG. 3 is a block diagram of an exemplary UE 300 according to some aspects of the present disclosure. The UE 300 may be a UE 115 as discussed with reference to FIG. 1 and shown in multiple figures. As shown, the UE 300 may include a processor 302, a memory 304, a sidelink reference signal (SL-RS) module 308, a transceiver 310 including a modem subsystem 312 and a radio frequency (RF) unit 314, and one or more antennas 316. These elements may be coupled with one another. The term “coupled” may refer to directly or indirectly coupled or connected to one or more intervening elements. For instance, these elements may be in direct or indirect communication with each other, for example via one or more buses.

The processor 302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 302 may also be implemented as a combination of computing devices, e.g., a combination of a DSP and a microprocessor, a plurality of microprocessors, one or more microprocessors in conjunction with a DSP core, or any other such configuration.

The memory 304 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 304 includes a non-transitory computer-readable medium. The memory 304 may store, or have recorded thereon, instructions 306. The instructions 306 may include instructions that, when executed by the processor 302, cause the processor 302 to perform the operations described herein with reference to a UE 115 or a BS 105 or other wireless communications device in connection with aspects of the present disclosure, for example, aspects of FIGS. 2 and 6A-12. Instructions 306 may also be referred to as code, which may be interpreted broadly to include any type of computer-readable statement(s).

The RIS channel estimation module 308 may be implemented via hardware, software, or combinations thereof. For example, the RIS channel estimation module 308 may be implemented as a processor, circuit, and/or instructions 306 stored in the memory 304 and executed by the processor 302. In some aspects, the RIS channel estimation module 308 can be integrated within the modem subsystem 312. For example, the RIS channel estimation module 308 can be implemented by a combination of software components (e.g., executed by a DSP or a general processor) and hardware components (e.g., logic gates and circuitry) within the modem subsystem 312. The RIS channel estimation module 308 may communicate with one or more components of the UE 300 to implement various aspects of the present disclosure, for example, aspects of FIGS. 2 and 6A-12.

The RIS channel estimation module 308 may be configured to perform various functions related to channel estimation or other data transfer between the UE 300 and a RIS (e.g., RIS 500 described hereafter). Such functions may include transmitting a password required for activating RFID tags of a RIS (e.g., RIS 500 and/or RIS 202), transmitting reference signals to the RIS, receiving channel estimation data from the RIS or from another wireless communications device, such as a BS (e.g., BS 400 and/or BS 105). In some aspects, the RIS channel estimation module 308 may additionally receive reference signals from RFID tags of the RIS by backscatter communication and perform channel measurements associated with the RFID tags by comparing the received references signals with an expected reference signal or a reference signal transmitted by the UE 300. The RIS channel estimation module 308 may additionally perform channel estimation of RIS elements of the RIS based on channel measurement data. In some aspects, the RIS channel estimation module 308 may determine a beam matrix containing ideal weights for each RIS element of the RIS. The RIS channel estimation module 308 may transmit the beam matrix to the RIS.

The UE 300 may be any one or more of a transmitting UE, a receiving UE, or a master UE. As a master UE, the UE 300 may be responsible for making the determinations related to reference signal parameters (e.g., sidelink reference signal parameters) discussed herein, as well as controlling the configuration of any RISs that may be involved (or communicating with the controller of the RIS to implement the desired parameters, including involving the RIS in beam training procedures with other UEs). The UE 300 may operate as different UE types with different groups (e.g., either concurrently or at different times). Where the UE 300 is not operating as a master UE, the UE 300 may nonetheless determine channel parameters between the UE 300 and the RIS 202 if they are received from the RIS 202, and transmit the resulting information to the RIS 202 for configuration.

As shown, the transceiver 310 may include the modem subsystem 312 and the RF unit 314. The transceiver 310 can be configured to communicate bi-directionally with other devices, such as the BSs 105. The modem subsystem 312 may be configured to modulate and/or encode the data from the memory 304 and/or the SL-RS module 308 according to a modulation and coding scheme (MCS), e.g., a low-density parity check (LDPC) coding scheme, a turbo coding scheme, a convolutional coding scheme, a digital beamforming scheme, etc. The RF unit 314 may be configured to process (e.g., perform analog to digital conversion or digital to analog conversion, etc.) modulated/encoded data (e.g., channel sensing reports, PUCCH UCI, PUSCH data, etc.) of transmissions originating from another source such as a UE 115, a BS 105, or an anchor. The RF unit 314 may be further configured to perform analog beamforming in conjunction with the digital beamforming. Although shown as integrated together in transceiver 310, the modem subsystem 312 and the RF unit 314 may be separate devices that are coupled together at the UE 300 to enable the UE 300 to communicate with other devices.

The RF unit 314 may provide the modulated and/or processed data, e.g. data packets (or, more generally, data messages that may contain one or more data packets and other information), to the antennas 316 for transmission to one or more other devices. The antennas 316 may further receive data messages transmitted from other devices. The antennas 316 may provide the received data messages for processing and/or demodulation at the transceiver 310. The transceiver 310 may provide the demodulated and decoded data (e.g., RRC table(s) for channel access configurations, scheduling grants, channel access configuration activation, timing advance configurations, RRC configurations, PUSCH configurations, SRS resource configurations, PUCCH configurations, BWP configurations, PDSCH data, PDCCH DCI, sidelink configurations, etc.) to the SL-RS module 308 for processing. The antennas 316 may include multiple antennas of similar or different designs in order to sustain multiple transmission links.

In an aspect, the UE 300 can include multiple transceivers 310 implementing different RATs (e.g., NR and LTE). In an aspect, the UE 300 can include a single transceiver 310 implementing multiple RATs (e.g., NR and LTE). In an aspect, the transceiver 310 can include various components, where different combinations of components can implement different RATs.

Further, in some aspects, the processor 302 is coupled to the memory 304 and the transceiver 310. The processor 302 is configured to determine, under control of the RIS channel estimation module 308, resources and/or parameters of reference signals, analyze and/or measure signal quality of references signals associated with different training beams, select optimal beams, generate, transmit, and/or receive beam training reports, implement reference signal parameters, and/or otherwise facilitate the transmission of data between the UE 400 and the RIS 302 (as an intermediary to final destination, such as a BS 105).

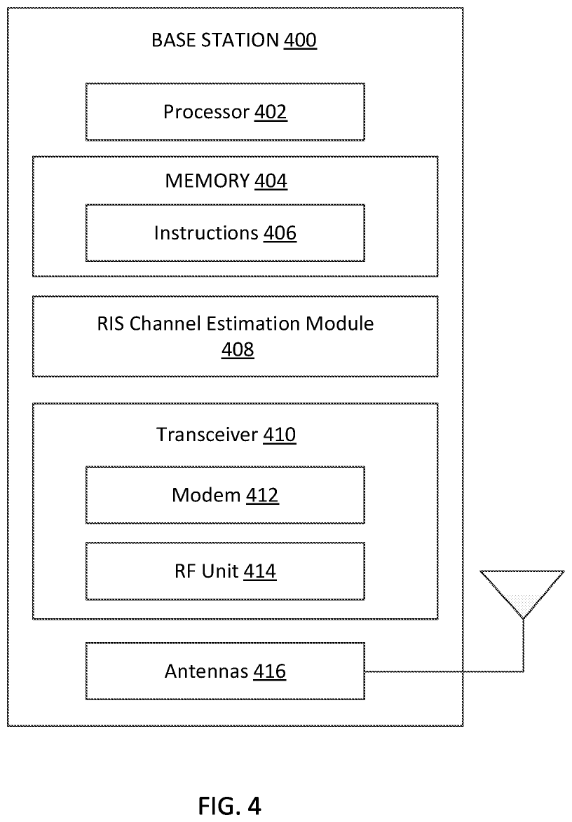

FIG. 4 is a block diagram of an exemplary BS 400 according to some aspects of the present disclosure. The BS 400 may be a BS 105 as discussed in FIG. 1, and/or a transmission reception point (TRP). For example, the BS 400 may be configured as one of multiple TRPs in a network configured for communication with at least one UE, such as one of the UEs 115. As shown, the BS 400 may include a processor 402, a memory 404, a sidelink reference signal (SL-RS) module 408, a transceiver 410 including a modem subsystem 312 and a RF unit 414, and one or more antennas 414. These elements may be coupled with one another. The term “coupled” may refer to directly or indirectly coupled or connected to one or more intervening elements. For instance, these elements may be in direct or indirect communication with each other, for example via one or more buses.

The processor 402 may have various features as a specific-type processor. For example, these may include a CPU, a DSP, an ASIC, a controller, an FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 404 may include a non-transitory computer-readable medium. The memory 404 may store instructions 406. The instructions 406 may include instructions that, when executed by the processor 402, cause the processor 402 to perform operations described herein, for example, aspects of FIGS. 2 and 6A-12. Instructions 406 may also be referred to as program code. The program code may cause a wireless communications device to perform these operations, for example by causing one or more processors (such as processor 402) to control or command the wireless communications device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The RIS channel estimation module 408 may be implemented via hardware, software, or combinations thereof. For example, the RIS channel estimation module 408 may be implemented as a processor, circuit, and/or instructions 406 stored in the memory 404 and executed by the processor 402. In some examples, the RIS channel estimation module 408 can be integrated within the modem subsystem 412. For example, the RIS channel estimation module 408 can be implemented by a combination of software components (e.g., executed by a DSP or a general processor) and hardware components (e.g., logic gates and circuitry) within the modem subsystem 412. The RIS channel estimation module 408 may communicate with one or more components of BS 400 to implement various aspects of the present disclosure, for example, aspects of FIGS. 2 and 6A-12.

The RIS channel estimation module 408 may be configured to perform various functions related to channel estimation or other data transfer between the BS 400 and a RIS (e.g., RIS 202). Such functions may include transmitting a password required for activating RFID tags of a RIS, transmitting reference signals to the RIS, receiving channel estimation data from the RIS or from another wireless communications device, such as a UE (e.g., UE 300 and/or UE 115). In some aspects, the RIS channel estimation module 408 may additionally receive reference signals from RFID tags of the RIS and perform channel measurements associated with the RFID tags by comparing the received references signals with an expected reference signal or a reference signal transmitted by the BS 400. The RIS channel estimation module 408 may additionally perform channel estimation of RIS elements of the RIS based on channel measurement data received from the RIS. In some aspects, the RIS channel estimation module 408 may determine a beam matrix containing ideal weights for each RIS element of the RIS. The RIS channel estimation module 408 may transmit the beam matrix to the RIS, such as to the RIS controller (where RFID tag is integrated with the controller), multiple RFID tags at the RIS), or some combination of the location of the RIS controller relative to the location(s) of the RFID tag(s).

As shown, the transceiver 410 may include the modem subsystem 412 and the RF unit 414. The transceiver 410 can be configured to communicate bi-directionally with other devices, such as the UEs 115 and/or BS 400 and/or another core network element. The modem subsystem 412 may be configured to modulate and/or encode data according to a MCS, e.g., a LDPC coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., RRC table(s) for channel access configurations, scheduling grants, channel access configuration activation, RRC configurations, PDSCH data, PDCCH DCI, RACH Preamble Assignments, random access messages, sidelink resource pool configuration, sidelink reference signal parameter configuration, etc.) from the modem subsystem 412 (on outbound transmissions) or of transmissions originating from another source such as a UE 115. The RF unit 414 may be further configured to perform analog beamforming in conjunction with the digital beamforming. Although shown as integrated together in transceiver 410, the modem subsystem 412 and/or the RF unit 414 may be separate devices that are coupled together at the BS 400 to enable the BS 400 to communicate with other devices.

The RF unit 414 may provide the modulated and/or processed data, e.g. data packets (or, more generally, data messages that may contain one or more data packets and other information), to the antennas 414 for transmission to one or more other devices. The antennas 414 may further receive data messages transmitted from other devices and provide the received data messages for processing and/or demodulation at the transceiver 410. The transceiver 410 may provide the demodulated and decoded data (e.g., PRACH messages, channel sensing reports, PUCCH UCI, PUSCH data, etc.) to the RIS channel estimation module 408 for processing. The antennas 414 may include multiple antennas of similar or different designs in order to sustain multiple transmission links.

In an aspect, the BS 400 can include multiple transceivers 410 implementing different RATs (e.g., NR and LTE). In an aspect, the BS 400 can include a single transceiver 410 implementing multiple RATs (e.g., NR and LTE). In an aspect, the transceiver 410 can include various components, where different combinations of components can implement different RATs.

Further, in some aspects, the processor 402 is coupled to the memory 404 and the transceiver 410. The processor 402 is configured to communicate, with a second wireless communications device via the transceiver 410, a plurality of channel access configurations. The processor 402 is further configured to communicate, with the second wireless communications device via the transceiver 410, a scheduling grant for communicating a communication signal in an unlicensed band, where the scheduling grant includes an indication of a first channel access configuration of the plurality of channel access configurations.

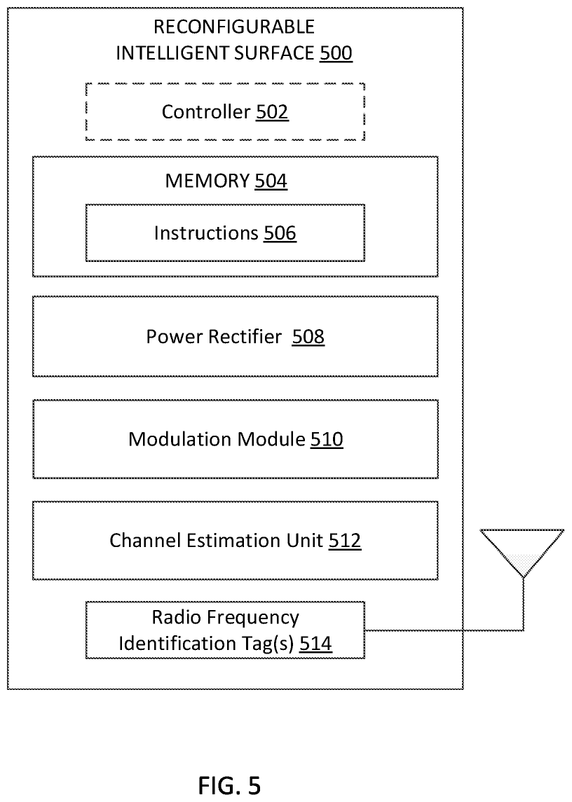

FIG. 5 is a block diagram of an exemplary reconfigurable intelligent surface (RIS) 500 according to some aspects of the present disclosure. As shown, the RIS 500 may include a processor 502, a memory 504 including instructions 506, a power rectifier 508, a modulation module 510, a channel estimation unit 512, and one or more radio frequency identification (RFID) tag(s) 514. These elements may be coupled with one another. The term “coupled” may refer to directly or indirectly coupled or connected to one or more intervening elements. For instance, these elements may be in direct or indirect communication with each other, for example via one or more buses.

The processor 502 may have various features as a specific-type processor. For example, these may include a CPU, a DSP, an ASIC, a controller, an FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 2 and 6A-12. Instructions 506 may also be referred to as program code. The program code may cause a wireless communications device to perform these operations, for example by causing one or more processors (such as processor 502) to control or command the wireless communications device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

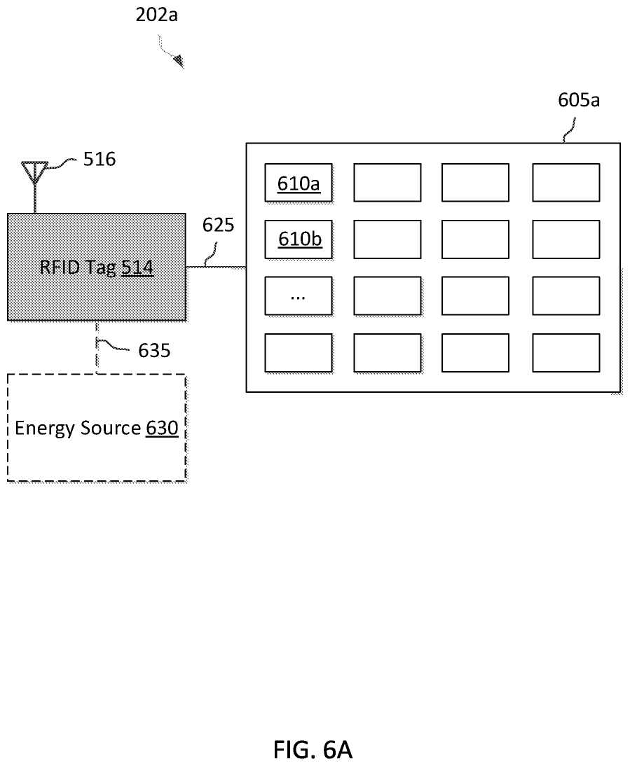

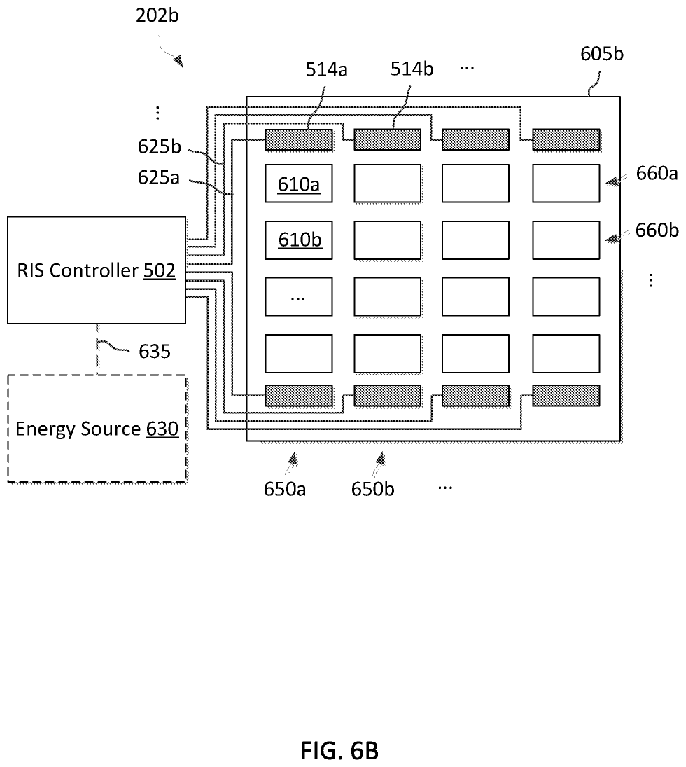

The power rectifier 508 of the RIS 500 may perform various functions. For example, the power rectifier 508 may modulate electrical energy input to the RIS 500 from, for example, a power source (e.g., energy source 630 of FIGS. 6A-6B). In some aspects, one or more RFID tags of the RIS 500 may include the power rectifier 508. In that regard, the power rectifier 508 may include various electrical components, such as a diode, a capacitor, or any other components. In some aspects, the power rectifier may modulate power received from a received RF signal from another wireless communications device. In some aspects, the power rectifier 508 may convert input power from a DC format to an AC format or vice versa.

The modulation module 510 may perform various functions related to backscattering of signals from the RFID tags of the RIS 500. In some aspects, one or more RFID tags of the RIS 500 may include the modulation module 510. The modulation module 510 may modulate signals received from a separate wireless communications device (e.g., the UE 300 and/or the BS 400). For example, an unmodulated or modulated signal may be received by the RFID tags of the RIS 500. In some aspects, a baseband processor or leaking carrier canceller may be implemented within the modulation module 510 to modulate signals received prior to backscattering. Such modulation may include inverting signals, adjusting a frequency, amplitude, or delay, or any other parameter of the received signals. In some aspects, the modulation module 510 may implement a state corresponding to a matched load for backscattering and a state corresponding to an open circuit when backscattering is not performed. In some aspects, the modulation module 510 may operate with various levels of efficiency. For example, a practical or idealized radiation power may correspond to a 1/3 ratio or 5 dB loss.

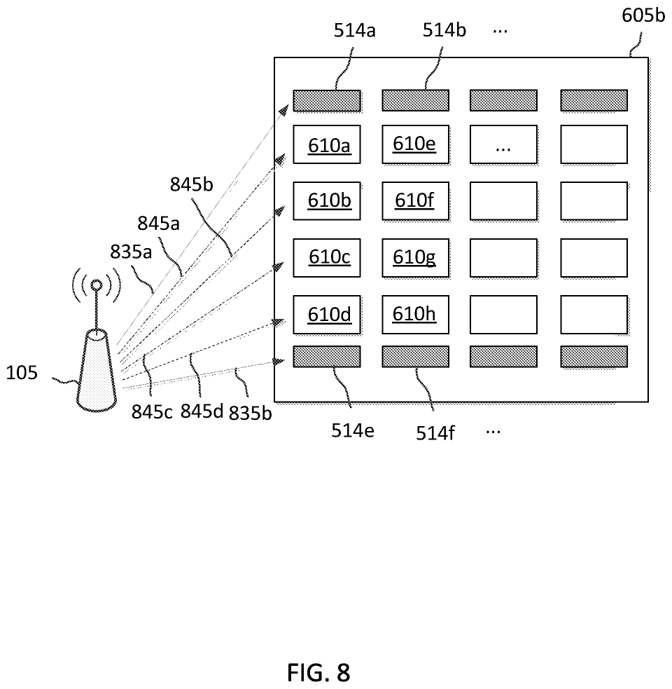

The channel estimation unit 512 may estimate channels of RIS elements of the RIS 500 based on measured channels. For example, channels of communication between a separate wireless communications device (e.g., UE 300 and/or BS 400) and RIS elements of the RIS 500 may be estimated. Estimation of channels between RIS elements and another wireless communication device may include first establishing communication between one or more RFID tags and the wireless communications device. Channels between the wireless communication device and the one or more RFID tags of the RIS 500 may then be measured. The channel estimation unit 512 may then estimate channels of individual RIS elements based on the channel measurements of the RFID tags. As explained in greater detail with reference to FIG. 8, this may be accomplished based on the relative positions of RFID tags and RIS elements, or based on any other parameters.

The radio frequency identification (RFID) tag(s) 514 of the RIS 500 may be configured to receive and or transmit or backscatter signals wirelessly. In some aspects, the RFID tags 514 may include various components of the RIS 500, including, for example, the power rectifier 508, the modulation module 510, or the channel estimation unit 512. In some aspects, RFID tags 514 may receive a forward link from a separate wireless communications device and may transmit a backscatter link in response to reception of the forward link. The RFID tags 514 may be passive, semi-passive, or active. In that regard, RFID tags 514 may be powered by an onboard energy source of the RIS 500, including, for example, an energy harvesting device, a battery, or any other device. In some aspects, the RFID tags 514 may include dipole antennas for transmission and reception of signals, as well as an integrated circuit (IC) for various processing of signals received or transmitted. RFID tags may provide several advantages over other components for wireless transmission, including lower cost as well as increased efficiency allowing implementation in passive or near-passive devices.

FIG. 6A illustrates a diagrammatic view of a RIS 202a with an RFID tag controller 514, according to some aspects of the present disclosure. As shown, the RIS 202a may include an RFID tag 514, a RIS surface 605a including a two-dimensional array of RIS elements 610, and an energy source 630.

In some aspects, as shown in FIG. 6A, the RIS 202a may use the RFID tag 514 as the controller (e.g., the controller 502). In that regard, the RFID tag 514 may perform various functions of a controller of a RIS. For example the RFID tag 514 may include a processor, a memory, an antenna 516, and any other suitable components. In some aspects, the processor of the RFID tag 514 may include one or more microchips. Alternatively, the RIS 202a may include a controller (e.g., controller 502) as well as RFID tag 514, where the RFID tag is contained within the controller or is in communication with the controller. Aspects discussed below are applicable in either scenario. In some aspects, the RFID tag 514 may alternatively include multiple antennas in addition to the antenna 516. Multiple antennas 516 may facilitate various beam forming techniques for directing beams received by or transmitted from the RIS 202a.

The RFID tag 514 may transmit and/or receive various signals, for example, by the antenna 414. Referring to FIG. 2, for example, the BS 105 may transmit a beam matrix to the RIS 202a. The beam matrix may be received by the antenna 516 and stored in the memory of the RFID tag 514. In some aspects, the processor of the RFID tag 514 may configure the weights 610 of the RIS surface 605a according to the beam matrix.

As shown by the link 625 in FIG. 6A, the RFID tag 514 may be in communication with the RIS surface 605a. In some aspects, the link 625 may include multiple conductors for conveying signals between the RIS 605a and the RFID tag 514. For example, the link 625 may include two or more conductors dedicated to each RSI element 610.

The RIS surface 605a may include any suitable number of RIS elements 610 arranged in any suitable way. For example, the RIS elements 610 shown in FIG. 6A may be arranged in a two-dimensional array. In some aspects, the RIS elements 610 may be arranged in a grid pattern, as shown, or may be arranged in any other way. In some aspects, the RIS elements 610 may alternatively form a 1D array.

FIG. 6A additionally depicts an energy source 630. In some aspects, the energy source 630 may provide energy to the RFID tag 514 and/or the RIS surface 605a. The energy source 630 may include a battery for storing energy as well as an energy harvesting element. The energy harvesting element may acquire energy in a variety of ways. For example, the energy harvesting element may include a solar panel configured to acquire energy from sunlight. The energy harvesting element may include a device configured to harvest energy in any other way, such as by converting thermal energy to electrical energy or converting mechanical energy to electrical energy, for example, from motion of wind or water. In some aspects, the energy harvesting device may acquire energy from radiofrequency transmissions, electro-magnetic waves, light, a laser source, or by any other method.

In some aspects, the energy harvesting element of the RFID tag 514 may be in electrical communication with a battery. The battery may store energy acquired by the energy harvesting element. The battery may discharge stored energy to power elements of the RFID tag 514 and/or RIS surface 605a.

The energy source 630 may be in communication with the RFID tag 514 by the link 635 to transfer electrical energy from the energy source 630 to the RFID tag 514. Electrical energy may be passed from the RFID tag 514 to the RIS surface 605a by the link 625. In some aspects, the energy source 630 may be additionally or alternatively in direct connection with the RFID surface 605a.

As shown in FIG. 6A, in some implementations, the energy source 630 may be an optional component of the RIS 202a. For example, the RIS 202a may be a fully passive RIS. A fully passive RIS may operate without a power source. In some aspects, a fully passive RIS may operate with energy harvested from a received signal from a separate wireless communications device, such as the BS 105 or the UE 115 described previously. In some aspects, the RIS 202a may be an active or semi-passive RIS 202a in which the energy source 630 may be included.

According to some aspects, the RIS 202a may advantageously require less power than conventional wireless communications devices. As a result, a greater number of energy sources may be used to power the RIS 202a, including smaller energy sources for more compact implementation or less expensive energy sources. This decreased energy demand may be a result of the use of the RFID tag 514 as a transceiver for the RIS 202a. For example, the RFID tag 514 may operate on a mere 10-30 μW of energy.

FIG. 6A describes aspects related to the RIS controller including, or being replaced by, an RFID tag 514. Alternatively or in addition, the RIS surface 605 may include multiple RFID tags spread amongst the RIS elements. This is illustrated and discussed with respect to FIG. 6B. FIG. 6B illustrates a diagrammatic view of a RIS 202b with RFID tags 514, according to some aspects of the present disclosure. The RIS 202b shown may include various features similar to the RIS 202a described with reference to FIG. 6A. The RIS 202b may additionally include the RIS controller 502, a RIS surface 605b including multiple RFID tags 514 and RIS elements 610, as well as the energy source 630.

As shown, the RIS surface 605b may include one or more RFID tags 514. The RFID tags 514 may be distributed across the RIS surface 605b in any arrangement. In the example shown, the RIS elements 610 may be arranged in a grid pattern forming multiple columns 650 and rows 660. As shown, RFID tags 514 may be aligned with each column 650 of the RIS elements 610 and positioned at a top and a bottom of each column 650. In other implementations, RFID tags 514 may be positioned at a right and left side of each row 660 of RIS elements 610. In other implementations, RFID tags 514 may be arranged in any other way. For example, RFID tags 514 may be positioned between RIS elements 610 in any position. Any number of RFID tags 514 may be positioned on the RIS surface 605b.

The RFID tags 514 shown in FIG. 6B may include any of the features described with reference to the RFID tag 514 of FIG. 6A and FIG. 5. For example, the RFID tags 514 of the RIS 202b may include a processor, a memory, an antenna, and any other suitable components. In some aspects, and as explained in greater detail with reference to FIG. 8 hereafter, channel estimations of RIS elements 610 may be made based on the positions of the RFID tags 514 relative to the RIS elements 610.

The RIS controller 502 may be in communication with the RFID tags 514 via links 625 shown. For example, the RFID tag 514a shown above the column 650a may be in wired communication with the RIS controller 502 via the link 625a. Similarly, the RFID tag 514b shown above the column 650b may be in communication with the RIS controller 502 via the link 625b. While not labeled explicitly, a separate link may further provide communication between each of the respective RFID tags 514 and the RIS controller 502. In some aspects, the links 625 may convey command signals from the RIS controller 502 to the RFID tags 514. In addition, signals received and/or processed by the RFID tags 514 may be transmitted to the RIS controller 502 via the links 625. For example, the RIS controller 502 may access memories of the RFID tags 514 by the links 625. In that regard, the RIS controller 502 may access control signals, reference signals, measurement information, estimation information, or any other information from the memories of RFID tags 514 by the links 625.

Any or all of the RFID tags 514 of the RIS surface 605b may be used as a transceiver of the controller 502. For example, in some aspects the controller 502 may not include an antenna, and therefore may not independently transmit or receive wireless signals. The RFID tags 514 of the RIS surface 605b may collect control information from the BS 105 and/or UE 115. Control information may include a beam index and/or beam matrix to be used at the RIS surface 605b. Control information may also include DCI related to timing or reflecting of signals by the RIS surface 605b. In some aspects, the DCI may include a sequence-based DCI used between the BS 105 and the RIS 202b. In some aspects, the RFID tags 514 may individually or jointly backscatter data from the RIS 202b to the BS 105 and/or the UE 115. Data backscattered from the RIS 202b may include an ACK of a DCI.

In some aspects, the RFID tags 514 may perform channel measurements of received reference signals. These channel measurements may correspond to channels between one or more RFID tags 514 and the BS 105 and/or between one or more RFID tags 514 and the UE 115.

In some aspects, a RIS 202 may include RFID tags positioned on the RIS surface 605b as well as one or more RFID tags included with the controller 502. In such an aspect, the controller 502 may transmit or receive signals via the RFID tag of the controller 502 and/or any of the other RFID tags 514 positioned on the RIS surface.

As described with reference to FIG. 2 previously, the positioning of RFID tags on the RIS surface 605b may enable channels between the RIS elements and other wireless communications devices to be estimated. Ideal RIS element weights may then be determined based on the channel estimations.

In one example, aspects of determining ideal RIS element weights may include beam training by sequentially transmitting a reference signal from the BS 105 to the UE 115 by reflecting transmitted signal off the RIS 202a (FIG. 6A). By assessing the quality of the reference signal received for each transmitted reference signal, the RIS element weights corresponding to the highest quality received signal may be implemented by the RIS 202a.

With multiple RFID tags distributed on the RIS surface 605b, the ideal RIS element weights may be determined without the sequential transmission of reference signals and modifying RIS element weights to find the ideal RIS element weights. Rather, a channel between each RFID tag of the RIS surface 605b and the BS 105 may be measured. Based on these channel measurements, for example, by interpolation or extrapolation, channels between RIS elements and the BS 105 may be estimated. The same process may be completed with respect to the RIS 202b and the UE 115. As a result, a matrix of estimated channels between the RIS elements of the RIS 202b and the BS 105 may be determined and an additional matrix of estimated channels between the RIS elements and the UE 115 may also be determined. A matrix including ideal weights of the RIS elements of the RIS 202b may then be determined such that the channels of these matrices are optimized. In that regard, the RIS elements of the RIS 202b may be trained after the BS 105 sends a single reference signal to the RIS 202b and the UE 115 sends a single reference signal to the RIS 202b. In this way, energy and processing power for training of a RIS is significantly reduced (with respect to each of communicating devices), the time of such training is also significantly reduced, and the accuracy of training is increased.

It is additionally noted that any subset of the RFID tags 514 of the RIS 202b may be enabled or disabled according to various functions. For example, the RIS controller 502 may transmit command signals to the RFID tags 514 instructing the RFID tags 514 to enter an enabled or disabled mode. An indication of which RFID tags 514 should be enabled for a particular function may be received by the RIS 202b from the UE 115 and/or the BS 105. In some aspects, the subset of RFID tags 514 enabled may be based on performance metrics. For example, the best RFID tags 514 may be selected to be enabled for communication to a controlling network unit (e.g., BS 105) and/or UE 115. That may be based on one or more signal quality metrics as determined from channel information. In some aspects, the RIS controller 502 may be the entity to determine which RFID tags 514 will be enabled or disabled based on performance metrics. In other aspects, the information may be sent to a BS 105 (or UE 115) for determination of which RFID tags 514 to enable or disable, which is sent to the RIS 202b to implement.

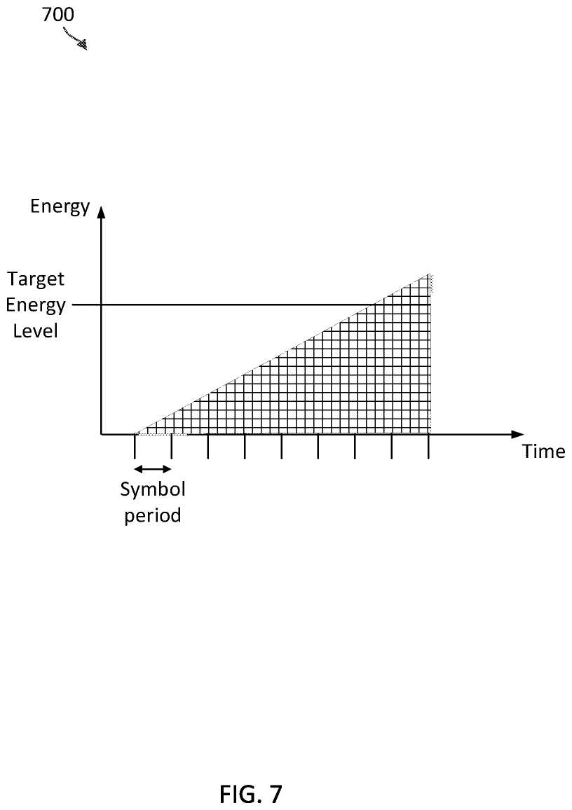

FIG. 7 illustrates a simplified diagram 700 of an energy charging scheme according to some aspects of the present disclosure. Diagram 700 represents charging by an energy harvesting RIS 202. In that regard, the simplified diagram 700 may illustrate aspects of a method implemented by the energy source 630. For example, the diagram 700 may represent aspects of a method implemented by an energy source 630 configured to harvest energy from RF signals transmitted from another wireless communications device, such as the BS 105 or UE 115. The vertical axis represents energy in some units, and the horizontal axis represents time in some units. The hashed portion of the graph represents the accumulating energy over time as harvested by an energy harvesting RIS 202. The horizontal axis is divided into symbol periods, which is the granularity with which communication occurs with the energy harvesting RIS 202.

As illustrated in diagram 700, a target energy level may be defined. The target energy level may be determined based on a data requirement indicated by a network unit such as a BS 105 or a UE 115. For example, the RIS 202 may specify a cycle or number of cycles representing the amount of time the RIS 202 is consuming power to perform any of the functions described herein. In that regard, a power requirement may be determined. In some aspects, a BS 105 or UE 115 may determine that for each cycle “on” duration, the RIS 202 will transmit a certain number of signals, receive a certain number of signals, and/or perform one or more other processing operations. The BS 105 or UE 115 may also have information about how much energy is used by the RIS 105 in performing those operations. Using this information, the BS 105 or UE 115 may determine a target energy level to which the UE will ideally charge between “on” durations so that during the “on” duration the RIS 202 has sufficient energy stored to perform the desired operations. The time needed by the RIS 202 to charge to the target energy level may be defined in units of symbol periods as shown.

FIG. 8 is a diagrammatic view of channel estimation for individual RIS elements, according to aspects of the present disclosure. As shown, FIG. 8 includes a view of the RIS surface 605b, a BS 105, and measured and estimated channels between the BS 105 and components of the RIS surface 605b. In other words, the example in FIG. 8 is based on multiple RFID tags across the RIS surface 605b, following the example of FIG. 6B.

In some aspects, the BS 105 may transmit a reference signal to a RIS (e.g., the RIS 202b). As explained with reference to FIG. 6B, a controller of the RIS may receive the reference signal by the RFID tags 514 of the RIS surface 605b. In that regard, each of the RFID tags 514 may receive the same reference signal from the BS 105 and may measure the channel for each RFID tag. In some aspects, any RFID tags 514 may receive separate or distinct reference signals from the BS 105 at the same time or at different times. As an illustrative example, the RFID tag 514a may receive the reference signal from the BS 105 and measure the channel 835a. The channel 835a may characterize parameters of communication from the BS 105 to the RFID tag 514a or vice versa. Similarly, the RFID tag 514e may receive the reference signal from the BS 105 and measure the channel 835b. In this way, each of the RFID tags 514 shown in FIG. 8 may receive the reference signal and measure corresponding channels, though each channel is not illustrated in FIG. 8.

The channels 845a, 845b, 845c, and 845d shown in FIG. 8 may correspond to channels of communication between the BS 105 and RIS elements 610a, 610b, 610c, and 610d of the RIS surface 605b respectively. Similar channels exist for each RIS element of the RIS surface 605b, though each channel may not be illustrated. Specifically, the channel 845a may represent a communication path from the BS 105 to the RIS element 610a, the channel 845b may represent a communication path from the BS 105 to the RIS element 610b, and so on. While in previous approaches the RIS elements 610 are not capable of measuring the respective channels 845 and thus determine ideal weights of each RIS element 610 of the RIS surface 605b, according to aspects of the present disclosure the channels from the BS 105 to each individual RIS element 610 may be obtained via extrapolation or interpolation from the channel estimates obtained for channels 835a and 835b (and so forth between each of the RFID tags 514 and the source). The channel estimates from the BS 105 to each individual RIS element 610 may be the matrix (described with reference to FIG. 2.

Because the channels 845 may not be measured directly by the RIS elements 610, the channels 845 may instead be estimated based on the measured channels 835. For example, a processor of any of the wireless communications devices described herein my implement various channel estimation techniques to estimate the channels 845. For example, any suitable interpolation or extrapolation techniques, as well as a minimized mean square error (MMSE) technique or any other channel estimation technique, may be implemented to estimate the channels 845. In this way, communication parameters from the BS 105 to each RIS element 610 may be estimated.

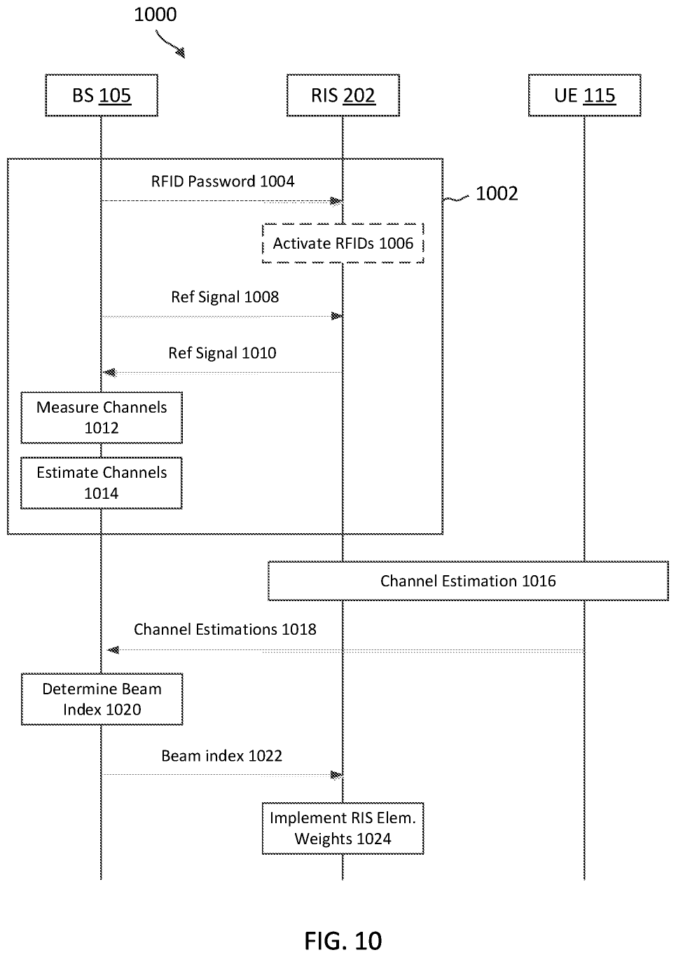

In some aspects, any suitable processing component of any suitable wireless communications device may perform measurement or estimation of channels. For example, the controller of the RIS 202 may estimate channels based on any channel estimation technique described above. In some aspects, RFID tags of the RIS 202 may perform channel estimation. A processor of the BS 105 may perform channel estimation (e.g., after receiving or performing channel measurements of the RFID tags of the RIS 202). A processor of the UE 115 may perform channel estimation (e.g., after receiving or performing channel measurements of the RFID tags of the RIS 202). Additional details of which components and/or wireless communications devices may perform various aspects of channel measurement and estimation will be described with reference to FIGS. 9-10 hereafter.

In the example shown, the channels 845a, 845b, 845c, and 845d corresponding respectively to RIS elements 610a, 610b, 610c, and 610d may be estimated based on the measured channels 835a and 835b corresponding respectively to RFID tags 514a and 514e. In some aspects, channels of RIS elements of the adjacent column may similarly be estimated. For example, channels corresponding to RIS elements 610e, 610f, 610g, and 610h may be estimated based on the measured channels of RFID tags 514b and 414f. In some aspects, the channels of any RIS elements 610 of the RIS surface 605b may be estimated based on measurements of any RFID tags. For example, estimations of channels 610e-f may be determined based on channel measurements of RFID tags 514a and 514e, as well as any other RFID tags 514. It is anticipated that the RFID tags and RIS elements may be positioned on the RIS surface 605b according to any suitable pattern. In that regard, the channel estimations of any of the RIS elements 610 may be determined based on the positions of the RIS elements 610 relative to any of the RFID tags 514.

In some aspects, and as will be explained in more detail with reference to FIGS. 9 and 10, different wireless communications devices may perform various steps of measuring and estimating channels of the RIS elements 610.

Turning now to FIG. 9, a signaling diagram 900 is illustrated of communication between the BS 105, the RIS 202, and the UE 115, according to aspects of the present disclosure. The signaling diagram 900 may be implemented by any suitable wireless communications devices. In some aspects, the BS 105 may utilize one or more components, such as the processor 402, the memory 404, the RIS channel estimation module 408, the transceiver 410, the modem 412, and the one or more antennas 414 shown in FIG. 4. As illustrated, the signaling diagram 900 includes a number of enumerated actions, but aspects of FIG. 9 may include additional actions before, after, and between the enumerated actions. In some aspects, one or more of the enumerated actions may be omitted, combined together, or performed in a different order.

Group 902 includes actions 904-916. Group 902 may correspond to a channel estimation process performed to measure and estimate channels between the BS 105 and RIS elements of the RIS 202.

At action 904, the BS 105 may transmit an RFID password to the RIS 202. In some aspects, RFID tags of the RIS 202 may be activated with a password. For example, a dedicated password may be preconfigured for an individual RFID tag. The RFID tag may begin to monitor for a transmitted signal, perform various processing functions, and/or transmit a signal only in response to receiving and decoding the dedicated password. In implementations in which the RIS 202 includes multiple RFID tags, each RFID tag may correspond to the same preconfigured password. In that regard, each RFID tag of the RIS 202 may simultaneously perform any of the functions described herein in response to receiving the same password.

In some aspects, action 904 may include transmitting additional command signals to the RIS. Command signals transmitted to the RIS 202 at action 904 may include a command packet, a modulated command packet, forward link, or any other command signals. In some aspects, command signals sent to the RIS 202 may include commands to power up one or more RFID tags, maintain an on status, or perform any other functions described herein. In some aspects, signal transmissions from the BS 105 to the RIS 202 may include backscattering communication from the RIS 202 to the BS 105. In some aspects, transmission from the BS to the RIS 202 may not include backscattering communication. For example, the action 904 may not include backscattering communication from the RIS 202 to the BS 105.

At action 906, the RFID tags of the RIS 202 may be activated. For example, the RFID tags may activate in response to receiving the same preconfigured password from the BS 105 at action 904.

At action 908, the BS 105 may transmit a reference signal to the RIS 202. In some aspects, the RIS 202 may include a single RFID tag, such as an RFID tag of the RIS controller, and/or may include multiple RFID tags distributed along the RIS surface. The reference signal transmitted from the BS 105 may be received by any of the RFID tags of the RIS 202.

At action 910, the RFID tags which received the reference signal may store the data received. For example, the RFID tags of the RIS 202 may each include a memory. The RFID tags may store the received reference signal in respective memories at action 910.

First describe RFID storing data, then controller accessing. Controller measures, estimates, writes to RFID memory, RFID sends to BS.

At action 912, the reference signal received at the RIS 202 may be analyzed to measure the channels of the RIS elements. In some aspects, this may include comparing a reference signal received by an RFID tag of the RIS 202 with an expected reference signal. In that regard, a channel measurement may document or account for changes between the reference signal received and the reference signal expected. In this way, the channel between each RFID tag of the RIS 202 may be quantified.

As explained hereafter, action 912 of the signaling diagram 900 may be performed by the RFID tags themselves, including all RFID tags or a subset of the RFID tags, or by a controller of the RIS 202. In that regard, action 912 may include accessing the reference signal stored within the memories of the RFID tags. For example, the controller of the RIS 202 may access the memory of each RFID tag which received a reference signal and read the data within the memory. The controller may than process the received reference signal to measure the channel corresponding to that particular RFID tag.

At action 914, the controller of the RIS 202 and/or one or more RFID tags of the RIS 202 may estimate the channels. In that regard, the controller and/or RFID tags may use any of the processes described with reference to FIG. 8 to estimate the channels associated with each of the RIS elements of the RIS 202. For example, because the RIS elements themselves are not able to measure channels from the BS 105 to the RIS elements, these channels may be estimated based on the measured channels of the RFID tags. In the example described above, in which the controller of the RIS 202 receives the reference signals from the RFID tags and processes the signals to measure the channels, the controller of the RIS 202 may additionally estimate the channels of the RIS elements based on the measured channels of the RFID tags and based on the position of the RFID tags distributed on the RIS surface relative to the RIS elements.

At action 916, the component which measured the RFID channels and/or estimated the RIS element channels (e.g., the controller of the RIS 202, an RFID of the controller, a subset of multiple RFID tags, etc.) may write the channel estimation data to the memories of the RFID tags. In some aspects, the only the channel estimation data corresponding to a particular RFID tag may be written to the memory of that tag. In some aspects, channel estimation data of multiple RFID tags may be written to the memory of one RFID tag. In some aspects, channel estimation data may be written to the memories of RFID tags which will be used to transmit the channel estimation data to the BS (e.g., at action 918).

At action 918, the channel estimation data may be transferred to the BS 105. In some aspects, this transfer of data may be completed by backscattering communication of the RFID tags. In that regard, the BS 105 may transmit a command signal which may request that the RFID tags transmit the channel estimation data. In some aspects, this command signal may also provide energy to be harvested by an energy harvesting device of the RIS 202 thus supplying the necessary energy to the transmitting RFID tags. All of the RFID tags may transmit channel estimation data or a subset of the RFID tags may transmit the channel estimation data. In some aspects, more than one RFID tag may jointly transmit channel estimation data. In some aspects, RFID tags may transmit channel estimation data separately. Some RFID tags may be configured to transmit the same channel estimation data to ensure that channel estimation data is properly transmitted from the RIS 202 to the BS 105.

In some regards, the channel estimation data may be transmitted from the RIS 202 to the UE 115. This may occur in response to a command signal from the UE 115 or the BS 105. For example, the BS 105 or the UE 115 may determine a beam matrix based on channel estimation data received. Although FIG. 9 depicts the channel estimation data transmitted to the BS 105, the RIS 202 may transmit the channel estimation data at action 918 to the wireless communications device which will determine the beam matrix for the RIS 202. For example, the signaling diagram 900 may illustrate a monostatic RFID communication method, in which the BS 105 transmits a command signal to the RIS 202 to initiate a backscatter communication of the channel estimations and also receives the channel estimations at action 918. In some aspects, however, a bistatic RFID communications method may be implemented in which the BS 105 may transmit the command signal for backscatter communications and the UE 115 may receive the channel estimations at action 918. In some aspects, the UE 115 may transmit the command and receive the channel estimations or the UE 115 may transmit the command and the BS 105 may receive the channel estimations.

Aspects of the actions 908-916 of the signaling diagram 900 may be performed by various components of the RIS 202, as described below.

In an aspect in which the RIS 202 includes two or more RFID tags distributed on the RIS surface, each RFID tag of the RIS 202 may receive the reference signal from the BS 105 at action 908. Each RFID tag may store the reference signal received from the BS 105 in a memory of each RFID tag (e.g., at action 910). In one aspect, a subset of the RFID tags of the RIS 202 may be selected to receive and process the reference signal stored in each RFID tag memory. For example, the subset may include a single RFID tag. The subset of RFID tags may be a subset of RFID tags on the controller of the RIS 202. Each RFID tag may convey their respective stored reference signal to the subset of RFID tags. The subset of RFID tags may be selected based on various characteristics of the subset of RFID tags. For example, the RFID tags of the subset may be RFID tags of increased processing capability or memory storage. In the aspect described, the subset of RFID tags may perform channel measurements for each RFID tag which received the reference signal (e.g., at action 912). The subset of RFID tags may then perform a channel estimation for each RIS element of the RIS 202 based on the channel measurements (e.g., at action 914). In the aspect described, the subset of RFID tags may transmit the channel estimations to the BS 105 (e.g., at action 918). In some aspects, the subset of RFID tags may write the channel estimations to the memories of each of the RFID tags of the RIS 202 and all of the RFID tags may transmit the channel estimations to the BS 105 at action 918.

In another aspect in which the RIS 202 includes two or more RFID tags distributed on the RIS surface, each RFID tag of the RIS 202 may receive the reference signal from the BS 105 at action 908. Each RFID tag may store the reference signal received from the BS 105 in a memory of each RFID tag (e.g., at action 910). Each RFID tag may convey their respective stored reference signal to the controller of the RIS 202. In some aspects, the controller of the RIS 202 may access the reference signal of each RFID tag. In the aspect described, the controller may perform channel measurements for each RFID tag which received the reference signal (e.g., at action 912). The controller may then perform a channel estimation for each RIS element of the RIS 202 based on the channel measurements (e.g., at action 914). In the aspect described, the controller may transmit the channel estimations to the BS 105, for example by an RFID tag of the controller (e.g., at action 918). In some aspects, the controller of the RIS 202 may write the channel estimations to the memories of each of the RFID tags of the RIS 202 and all of the RFID tags may transmit the channel estimations to the BS 105 at action 918.

In another aspect in which the RIS 202 includes two or more RFID tags distributed on the RIS surface, each RFID tag of the RIS 202 may receive the reference signal from the BS 105 at action 908. Each RFID tag may then perform channel measurements. In some aspects, each of the RFID tags may then store the channel measurements in a respective memory. Each RFID tag may convey their respective stored channel measurements to the controller of the RIS 202 and/or a subset of RFID tags. In some aspects, the controller of the RIS 202 or subset of RFID tags may access the channel measurements of each RFID tag. In the aspect described, the controller or subset of RIFD tags may then a channel estimation for each RIS element of the RIS 202 based on the channel measurements. In the aspect described, the controller or subset of RFID tags may transmit the channel estimations to the BS 105, for example by an RFID tag of the controller. In some aspects, the controller of the RIS 202 or subset of RFID tags may write the channel estimations to the memories of each of the RFID tags of the RIS 202 and all of the RFID tags may transmit the channel estimations to the BS 105 at action 918.

In another aspect in which the RIS 202 includes two or more RFID tags distributed on the RIS surface, each RFID tag of the RIS 202 may receive the reference signal from the BS 105 at action 908. Each RFID tag may then perform channel measurements (e.g., at action 912) and perform channel estimations (e.g., at action 914). In this way, actions 910 and 916 may not be completed. In the aspect described, the RFID tags may transmit the channel estimations to the BS 105 (e.g., at action 918).

At action 920, channel estimation may be completed with respect to the UE 115. For example, referring again to the description of FIG. 2, previously, the group 902 describes various methods of estimating channels between the BS 105 and individual RIS elements of the RIS 202. These channel estimations may be included in the matrix G. At action 920, channels between the UE 115 and individual elements of the RIS 202 may be estimated. These channel estimation may be included in the matrix H. In some aspects, action 920 may be a group of actions similar to the group 902. In that regard, the action 920 may include any of the actions 904-916 but with respect to the UE 115. For example, the UE 115 may transmit an RFID password to the RIS 202 and the RFID tags may be activated. The UE 115 may then transmit a reference signal to the RIS 202. RFID tags of the RIS 202 may store the reference signal and any of the components of the RIS 202 may measure the channels of the RFID tags and estimate the channels of the RIS elements by transferring any information and any of the processing methods described previously with reference to actions 908-916.

In some aspects, the signaling diagram 900 may include the action 922. At action 922, the channel estimation data acquired at action 920 may be transmitted to the BS 105. In some aspects, this transmission may be facilitated by the RIS 202. At action 922, the channel estimations of the BS 105 and the channel estimations of the UE 115 may be moved to the same wireless communications device prior to the action 924. In that regard, the channel estimations of the UE 115 may be transmitted to the BS 105, as shown. In other aspects, the channel estimations of the BS 105 may be transmitted to the UE 115. In such an aspect, the UE 115 may perform action 924. As will be described in more detail hereafter, in some aspects, the RIS 202 may perform the action 924.

At action 924, the BS 105 may determine the beam matrix for the RIS 202. As described with reference to FIG. 2, determining the beam matrix at action 924 may include determining optimal RIS element weights of the matrix Φ based on the matrix G corresponding to the BS 105 and the matrix H corresponding to the UE 115. In some aspects, the UE 115 may perform the action 924.

At action 926, the BS 105 may transmit the beam matrix to the RIS 202. In some aspects, the UE 115 may transmit the beam matrix to the RIS 202. The RIS 202 may receive the beam matrix by the RFID tags of the RIS 202. For example, each of the RFID tags distributed on the RIS surface may jointly receive the beam matrix.

In some aspects, the beam matrix may be transmitted to a subset of the RFID tags of the RIS 202. In that regard, beamforming and reliability of the transmission may be improved. In some aspects, the beam matrix may be divided for transmission. For example, a first portion of the beam matrix may be transmitted to a first subset of the RFID tags and a second portion of the beam matrix may be transmitted to a second subset of the RFID tags. A controller of the RIS 202 or one or more RFID tags of the RIS 202 may then access the first and second portions of the beam matrix and combine them to form the complete beam matrix. It is noted that the beam matrix may be divided into any suitable number of portions and the RFID tags may be divided into a corresponding number of subsets configured to receive each of the portions of the beam matrix.

At action 928, the RIS 202 may implement the RIS element weights. For example, each RIS element may be modified according to the weights within the beam matrix received at actions 926.

In some aspects, a controller or subset of RFID tags of the RIS 202 may perform the action 924 of determining the beam matrix. In such aspects, the signaling diagram 900 may include the group 902 as described previously, the action or group 920 as described previously, followed by the actions 924 and 928, both performed by the RIS 202. For example, the BS 105 may transmit a reference signal to the RIS 202 and the RIS 202 (by the controller or one or more RFID tags) may perform channel measurement and estimation. The channel estimation of the BS 105 (e.g., matrix G) may then be stored at the RIS 202. The UE 115 may then transmit a reference signal to the RIS 202 and the RIS 202 may perform channel measurement and estimation for the UE 115 (e.g., matrix H). This channel estimation may also be stored at the RIS 202. The RIS 202 may then determine the beam matrix at action 924 and implement the RIS element weights based on the beam matrix at action 928. In some aspects, the RIS 202 may additionally send a notification to the BS 105 and/or the UE 115 indicating that the beam matrix was determined and implemented such that elements of the RIS 202 are optimized for communication between the BS 105 and the UE 115.

FIG. 10 is a signaling diagram of communication between a BS, a RIS, and a UE, according to aspects of the present disclosure. The signaling diagram 1000 may be implemented by any suitable wireless communications devices. In some aspects, the BS 105 may utilize one or more components, such as the processor 402, the memory 404, the RIS channel estimation module 408, the transceiver 410, the modem 412, and the one or more antennas 414 shown in FIG. 4. As illustrated, the signaling diagram 1000 includes a number of enumerated actions, but aspects of FIG. 10 may include additional actions before, after, and between the enumerated actions. In some aspects, one or more of the enumerated actions may be omitted, combined together, or performed in a different order.

Group 1002 includes actions 1004-1014. Group 1002 may correspond to a channel estimation process performed to measure and estimate channels between the BS 105 and RIS elements of the RIS 202.

The action 1004 may be substantially similar to the action 904 described with reference to FIG. 9. At action 1004, the BS 105 may transmit an RFID password to the RIS 202. As previously described, if the RIS 202 includes multiple RFID tags, each RFID tag may correspond to the same preconfigured password. However, aspects of the signaling diagram 1000 may be performed by a RIS 202 including only a single RFID tag.

At action 1006, the RFID tags of the RIS 202 may be activated. For example, the RFID tags may activate in response to receiving the preconfigured password from the BS 105 at action 1004.

At action 1008, the BS 105 may transmit a reference signal to the RIS 202. In some aspects, the RIS 202 may include a single RFID tag, such as an RFID tag of the RIS controller. The reference signal transmitted from the BS 105 may be received by any of the RFID tags of the RIS 202.

At action 1010, the RFIDs of the RIS 202 may backscatter a signal to the BS 105. In some aspects, the backscattered signal may include the same reference signal received by RFID tags of the RIS 202 at action 1008. In some aspects, however, the reference signal received by the RFID tags has been modified in any of the ways previously described during wireless transmission of the reference signal.

At action 1012, the reference signal received at the BS 105 from the RIS 202 may be analyzed to measure the channels of the RIS elements. In some aspects, this may include comparing the reference signal received with the references signal transmitted. In that regard, a channel measurement may document or account for changes between the reference signal received and the reference signal transmitted. In this way, the channel between each RFID tag of the RIS 202 and teh BS 105 may be quantified.

In some aspects, as described with reference to FIG. 9 previously, the RIS 202, including the controller and/or RFID tags of the RIS 202 may perform the channel measurements action 1012. In that regard, the RIS 202 may perform channel measurements and transmit the channel measurements to the BS 105 prior to the action 1014.

At action 1014, the BS 105 may estimate the channels. In that regard, BS 105 may use any of the processes described with reference to FIG. 8 to estimate the channels associated with each of the RIS elements of the RIS 202.

At action 1016, channel estimation may be completed with respect to the UE 115. For example, the group 1002 describes estimating channels between the BS 105 and RIS elements of the RIS 202 and action 1016 may include any of the same actions of the group 1002 to estimate channels between the UE 115 and individual elements of the RIS 202. In that regard, action 1016 may be a group of actions similar to the group 1002. For example, the UE 115 may transmit an RFID password to the RIS 202 and the RFID tags may be activated. The UE 115 may then transmit a reference signal to the RIS 202 and the RFID tags of the RIS 202 may transmit the reference signal back to the UE 115. The UE 115 may then measure the channels of the RFID tags and estimate the channels of the RIS elements.

At action 1018, the channel estimation data acquired at action 1016 may be transmitted to the BS 105. In some aspects, this transmission may be facilitated by the RIS 202. At action 1016, the channel estimations of the BS 105 and the channel estimations of the UE 115 may be moved to the same wireless communications device prior to the action 1020. In that regard, the channel estimations of the UE 115 may be transmitted to the BS 105, as shown. In other aspects, the channel estimations of the BS 105 may be transmitted to the UE 115. In such an aspect, the UE 115 may perform action 1020. As will be described with reference to action 924, similarly, the RIS 202 may perform the action 1020.

At action 1020, the BS 105 may determine the beam matrix for the RIS 202. As described with reference to FIG. 2, determining the beam matrix at action 924 may include determining optimal RIS element weights of the matrix @ based on the matrix (corresponding to the BS 105 and the matrix H corresponding to the UE 115. In some aspects, the UE 115 may perform the action 1020.

At action 1022, the BS 105 may transmit the beam matrix to the RIS 202. In some aspects, the UE 115 may transmit the beam matrix to the RIS 202. The RIS 202 may receive the beam matrix by the RFID tags of the RIS 202. For example, each of the RFID tags distributed on the RIS surface may jointly receive the beam matrix or receive portions of the beam matrix as described with reference to action 926 of FIG. 9.

At action 1024, the RIS 202 may implement the RIS element weights. For example, each RIS element may be modified according to the weights within the beam matrix received at actions 1022.

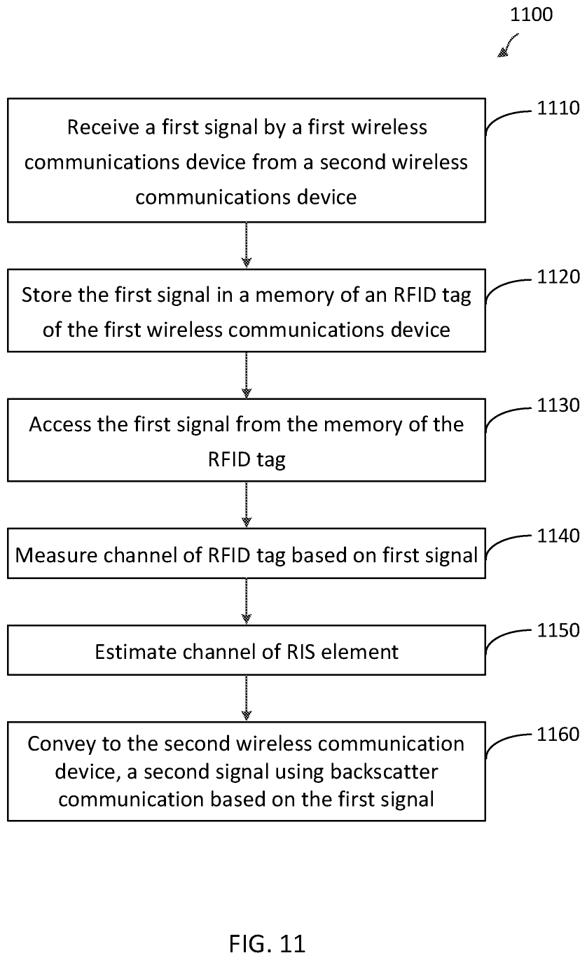

FIG. 11 is a flow diagram of a wireless communication method 1100, according to some aspects of the present disclosure. Aspects of the method 1100 can be executed by a computing device (e.g., a processor, processing circuit, and/or other suitable component) of a wireless communications device or other suitable means for performing the aspects. For example, a wireless communications device, such as the RIS 500, may utilize one or more components, such as the processor 502, the memory 504, the power rectifier 508, the modulation module 510, the channel estimation module 512, and/or the RFID tags 514 to execute aspects of method 1100. The method 1100 may employ similar mechanisms as the actions described with respect to FIGS. 5-10. As illustrated, the method 1100 includes a number of enumerated aspects, but the method 1100 may include additional aspects before, after, and/or in between the enumerated aspects. In some aspects, one or more of the enumerated aspects may be omitted or performed in a different order.

At block 1110, a first wireless communications device receives a first signal from a second wireless communications device. The first wireless communications device may comprise a reconfigurable intelligent surface (RIS) including an array of one or more RIS elements; a RIS controller; and a radio frequency identification (RFID) tag, the first signal being received by the RFID tag. In some aspects, the first signal may include a password required to activate the RFID tag, a reference signal, DCI, or any other signal. In some aspects, the first signal may be a reference signal.

At block 1120, the first wireless communications device may store the first signal in a memory of an RFID tag of the first wireless communications device. In some aspects, each RFID tag of a RIS (e.g., the RIS 202, the RIS 500, or any other RIS) may receive the first signal and each RFID tag may store the first signal in the respective memory of each RFID.

At block 1130, the first wireless communications device may access the first signal from the memory of the RFID tag. In some aspects, a controller of the RIS may access the first signal. In some aspects, an RFID tag of the controller may access the first signal at block 1130. In some aspects, the controller of the RIS may be an RFID tag.

At block 1140, the first wireless communications device may measure a channel of the RFID tag based on the first signal. In some aspects, the channel of each RFID tag of the first wireless communications device may be measured. A controller of the first wireless communications device may measure the channels of the RFID tags. An RFID tag of the controller may measure the channels of the RFID tags. The channels of the RFID tags may be measured in any suitable way. For example, the controller of the first wireless communications device may compare the first signal received at block 1110 with an expected reference signal. Based on this comparison, the controller of the first wireless communications device may determine one or more values to characterize the channel of communication respective to each RFID tag. These values may be included in the channel estimation information.

At block 1150, the first wireless communications device may estimate a channel of a RIS element. In that regard, the first wireless communications device may estimate the channels of each RIS element of the RIS surface of the first wireless communications device. As described with reference to FIG. 8, this channel estimation may be based on various channel estimation techniques, such as interpolation, extrapolation, or MMSE of the measured channels of the RFID tags. The channel estimation of each RIS element may be an approximation of a channel measurement of the RIS elements. In that regard, channel estimations similarly characterize how a signal is modulated from the second wireless communications device to the RIS elements of the first wireless communications device.

At block 1160, the first wireless communications device conveys, by the RFID tag of the first wireless communications device to the second wireless communications device, a second signal using backscatter communication based on the first signal. In some aspects, the second signal may include the a reference signal received by the RFID tag at block 1110, channel measurement data corresponding to the RFID tag, channel estimation data of RIS elements of the RIS 202, or any other signals. In some aspects, the RIS 202, by a controller or RFID tag(s), may perform channel measurement and estimation prior to transmitting the second signal.

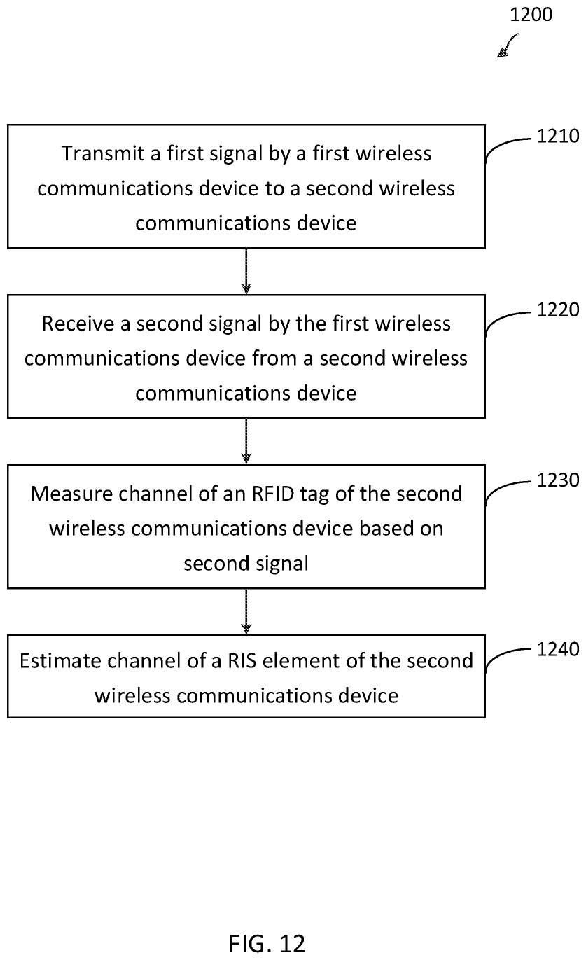

FIG. 12 is a flow diagram of a wireless communication method 1200, according to some aspects of the present disclosure. Aspects of the method 1200 can be executed by a computing device (e.g., a processor, processing circuit, and/or other suitable component) of a wireless communications device or other suitable means for performing the aspects. For example, a wireless communications device, such as the UE 115, may utilize one or more components, such as the processor 302, the memory 304, the RIS channel estimation module 308, the transceiver 310, the modem 312, and the one or more antennas 316, to execute aspects of method 1200. In some aspects, a wireless communications device, such as the BS 105, may utilize one or more components, such as the processor 402, the memory 404, the RIS channel estimation module 408, the transceiver 410, the modem 412, and the one or more antennas 414, to execute aspects of method 1000. The method 1200 may employ similar mechanisms as the actions described with respect to FIGS. 5-10. As illustrated, the method 1200 includes a number of enumerated aspects, but the method 1200 may include additional aspects before, after, and/or in between the enumerated aspects. In some aspects, one or more of the enumerated aspects may be omitted or performed in a different order.

At block 1210, a first wireless communications device may transmit a first signal to a second wireless communications device. In some aspects, the first wireless communications device may be a base station or a user equipment. In some aspects, the second wireless communications device may be a RIS (e.g., the RIS 202 and/or 500). The second wireless communications device may include a reconfigurable intelligent surface (RIS) including an array of one or more RIS elements; a RIS controller; and a radio frequency identification (RFID) tag, the first signal being received by the RFID tag. In some aspects, the first signal may be a reference signal. The second wireless communications device may receive the first signal by the RFID tag. In some aspects, the second wireless communications device may include multiple RFID tags. In such a case, the second wireless communications device may receive the first signal by the multiple RFID tags.

At block 1220, the first wireless communications device may receive a second signal from the second wireless communications device. In some aspects, the second signal may be a reference signal. In some aspects, the second signal may include the information received by the second wireless communications device at block 1210. In that regard, the second signal may correspond to the same reference signal as the first signal, but may have been modulated or otherwise modified by the communication channels between the first wireless communications device and the second wireless communications device. In some aspects, the second signal may include channel measurement data or channel estimation data, as described with reference to FIGS. 9-10.

At block 1230, the first wireless communications device may measure the channel of an RFID tag of the second wireless communications device based on the second signal. In some aspects, the first wireless communications device may measure the channels of each RFID of the second wireless communications devices. The first wireless communications device may measure the channels of the RFID tags. The channels of the RFID tags may be measured by comparing the first signal transmitted at block 1210 with the second signal received at step 1220. Based on this comparison, the first wireless communications device may determine one or more values to characterize the channel of communication respective to each RFID tag of the second wireless communications device.

At block 1240, the first wireless communications device may estimate the channel of a RIS element of the second wireless communications device. In that regard, the first wireless communications device may estimate the channels of each RIS element of the RIS surface of the second wireless communications device based on the channel measurement data of block 1230. As described with reference to FIG. 8, this channel estimation may be based on various channel estimation techniques, such as interpolation, extrapolation, or MMSE of the measured channels of the RFID tags. The channel estimation of each RIS element may be an approximation of a channel measurement of the RIS elements. In that regard, channel estimations similarly characterize how a signal is modulated from the first wireless communications device to the RIS elements of the second wireless communications device.

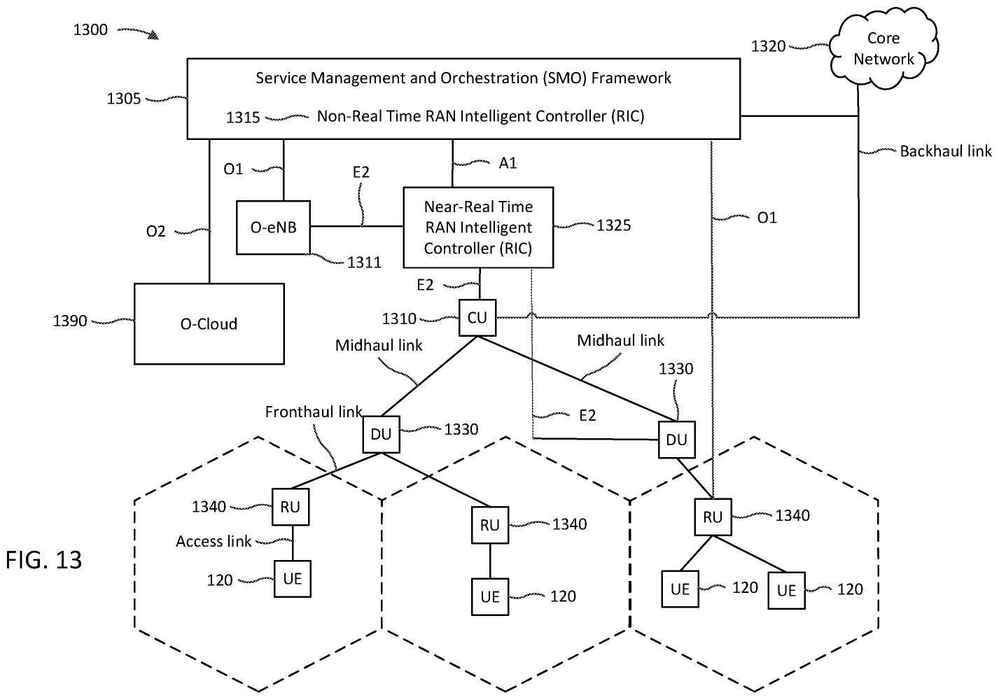

FIG. 13 shows a diagram illustrating an example disaggregated base station 1300 architecture. The disaggregated base station 1300 architecture may include one or more central units (CUs) 1310 that can communicate directly with a core network 1320 via a backhaul link, or indirectly with the core network 1320 through one or more disaggregated base station units (such as a Near-Real Time (Near-RT) RAN Intelligent Controller (RIC) 1325 via an E2 link, or a Non-Real Time (Non-RT) RIC 1315 associated with a Service Management and Orchestration (SMO) Framework 1305, or both). A CU 1310 may communicate with one or more distributed units (DUs) 1330 via respective midhaul links, such as an F1 interface. The DUs 1330 may communicate with one or more radio units (RUs) 1340 via respective fronthaul links. The RUs 1340 may communicate with respective UEs 120 via one or more radio frequency (RF) access links. In some implementations, the UE 120 may be simultaneously served by multiple RUs 1340. Aspects of the present disclosure described as occurring at, or controlled by, a BS may occur at any one or more of these different units.

Each of the units, i.e., the CUS 1310, the DUs 1330, the RUs 1340, as well as the Near-RT RICs 1325, the Non-RT RICs 1315 and the SMO Framework 1305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1310. The CU 1310 may be configured to handle user plane functionality (i.e., Central Unit-User Plane (CU-UP)), control plane functionality (i.e., Central Unit-Control Plane (CU-CP)), or a combination thereof. In some implementations, the CU 1310 can be logically split into one or more CU-UP units and one or more CU-CP units. The CU-UP unit can communicate bidirectionally with the CU-CP unit via an interface, such as the E1 interface when implemented in an O-RAN configuration. The CU 1310 can be implemented to communicate with the DU 1330, as necessary, for network control and signaling.

The DU 1330 may correspond to a logical unit that includes one or more base station functions to control the operation of one or more RUs 1340. In some aspects, the DU 1330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1330 may further host one or more low PHY layers. Each layer (or module) can be implemented with an interface configured to communicate signals with other layers (and modules) hosted by the DU 1330, or with the control functions hosted by the CU 1310.

Lower-layer functionality can be implemented by one or more RUs 1340. In some deployments, an RU 1340, controlled by a DU 1330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1340 can be implemented to handle over the air (OTA) communication with one or more UEs 120. In some implementations, real-time and non-real-time aspects of control and user plane communication with the RU(s) 1340 can be controlled by the corresponding DU 1330. In some scenarios, this configuration can enable the DU(s) 1330 and the CU 1310 to be implemented in a cloud-based RAN architecture, such as a vRAN architecture.

The SMO Framework 1305 may be configured to support RAN deployment and provisioning of non-virtualized and virtualized network elements. For non-virtualized network elements, the SMO Framework 1305 may be configured to support the deployment of dedicated physical resources for RAN coverage requirements which may be managed via an operations and maintenance interface (such as an O1 interface). For virtualized network elements, the SMO Framework 1305 may be configured to interact with a cloud computing platform (such as an open cloud (O-Cloud) 1390) to perform network element life cycle management (such as to instantiate virtualized network elements) via a cloud computing platform interface (such as an O2 interface). Such virtualized network elements can include, but are not limited to, CUs 1310, DUs 1330, RUs 1340 and Near-RT RICs 1325. In some implementations, the SMO Framework 1305 can communicate with a hardware aspect of a 4G RAN, such as an open eNB (O-eNB) 1311, via an O1 interface. Additionally, in some implementations, the SMO Framework 1305 can communicate directly with one or more RUs 1340 via an O1 interface. The SMO Framework 1305 also may include a Non-RT RIC 1315 configured to support functionality of the SMO Framework 1305.

The Non-RT RIC 1315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1325. The Non-RT RIC 1315 may be coupled to or communicate with (such as via an A1 interface) the Near-RT RIC 1325. The Near-RT RIC 1325 may be configured to include a logical function that enables near-real-time control and optimization of RAN elements and resources via data collection and actions over an interface (such as via an E2 interface) connecting one or more CUs 1310, one or more DUs 1330, or both, as well as an O-eNB, with the Near-RT RIC 1325.

In some implementations, to generate AI/ML models to be deployed in the Near-RT RIC 1325, the Non-RT RIC 1315 may receive parameters or external enrichment information from external servers. Such information may be utilized by the Near-RT RIC 1325 and may be received at the SMO Framework 1305 or the Non-RT RIC 1315 from non-network data sources or from network functions. In some examples, the Non-RT RIC 1315 or the Near-RT RIC 1325 may be configured to tune RAN behavior or performance. For example, the Non-RT RIC 1315 may monitor long-term trends and patterns for performance and employ AI/ML models to perform corrective actions through the SMO Framework 1305 (such as reconfiguration via 01) or via creation of RAN management policies (such as A1 policies).

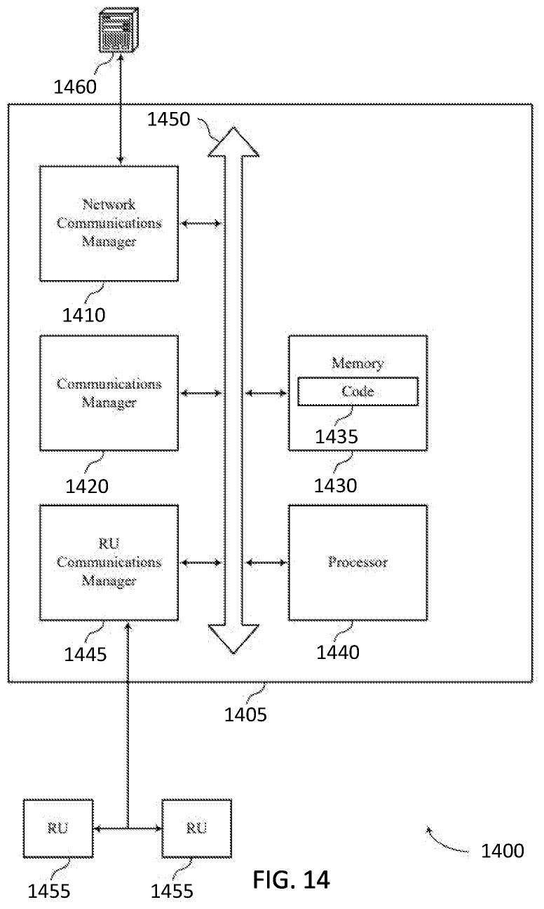

FIG. 14 shows a diagram of a system 1400 including a device 1405 that supports RU sharing techniques in wireless communications in accordance with aspects of the present disclosure. The device 1405 may communicate with one or more RUs 1455. The device 1405 may include components for bi-directional voice and data communications including components for transmitting and receiving communications, such as a communications manager 1420, a network communications manager 1410, a memory 1430, code 1435, a processor 1440, and a RU communications manager 1445. These components may be in electronic communication or otherwise coupled (e.g., operatively, communicatively, functionally, electronically, electrically) via one or more buses (e.g., a bus 1450). One or more of the components of system 1400 may perform functions as described herein with reference to FIGS. 5-10, for example functions described as performed by a base station or network unit.

The network communications manager 1410 may manage communications with a core network 1460 (e.g., via one or more wired backhaul links). For example, the network communications manager 1410 may manage the transfer of data communications for client devices, such as one or more UEs 115.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting RU sharing techniques in wireless communications). For example, the device 1405 or a component of the device 1405 may include a processor 1440 and memory 1430 coupled to the processor 1440, the processor 1440 and memory 1430 configured to perform various functions described herein.

The RU communications manager 1445 may manage communications with RUs 1455 and may include a controller or scheduler for controlling communications with UEs 115 in cooperation with RUs 1455. For example, the RU communications manager 1445 may coordinate scheduling for transmissions to UEs 115. In some examples, the RU communications manager 1445 may provide an F1 interface within a wireless communications network technology to provide communication with RUs 1455.

The communications manager 1420 may support wireless communications at a network node in accordance with examples as disclosed herein. For example, the communications manager 1420 may be configured as or otherwise support a means for transmitting, to a first RU, a request for a wireless resource configuration for a first time period. The communications manager 1420 may be configured as or otherwise support a means for transmitting, to a second RU, an interference inquiry associated with the wireless resource configuration for the first time period. The communications manager 1420 may be configured as or otherwise support a means for receiving, from the second RU, a response to the interference inquiry. The communications manager 1420 may be configured as or otherwise support a means for transmitting, based on the response to the interference inquiry, a payload to the first RU for transmission during the first time period.

By including or configuring the communications manager 1420 in accordance with examples as described herein, the device 1405 may support techniques for RU sharing in which DUs of different MNOs may access wireless resources of other MNOs, which may increase efficiency of resource usage while provide for competition and innovation among different MNOs, may increase the reliability of wireless communications, decrease latency, and enhance user experience.

In some examples, the communications manager 1420 may be configured to perform various operations (e.g., receiving, monitoring, transmitting) using or otherwise in cooperation with other components. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of RU sharing techniques in wireless communications as described herein, or the processor 1440 and the memory 1430 may be otherwise configured to perform or support such operations.

Further aspects of the present disclosure include the following:

Aspect 1 includes a method of wireless communication, comprising: receiving a first signal by a first wireless communications device from a second wireless communications device, the first wireless communications device further comprising: a reconfigurable intelligent surface (RIS) including an array of one or more RIS elements; a RIS controller; and conveying, by the RFID tag of the first wireless communications device to the second wireless communications device, a second signal using backscatter communication based on the first signal.

Aspect 2 includes the method of aspect 1, wherein the RIS controller comprises the RFID tag.

Aspect 3 includes the method of any of aspects 1-2, wherein the RFID tag comprises a plurality of RFID tags amongst the array of one or more RIS elements, the plurality of RFID tags in communication with the RIS controller.

Aspect 4 includes the method of any of aspects 1-3, wherein the first signal comprises a reference signal.

Aspect 5 includes the method of any of aspects 1-4, wherein the second signal includes channel estimation information.

Aspect 6 includes the method of any of aspects 1-5, further comprising determining, by the plurality of RFID tags, the channel estimation information, wherein the conveying the second signal is by the plurality of RFID tags.

Aspect 7 includes the method of any of aspects 1-6, wherein the first wireless communications device further comprises a channel estimation unit, the method further comprising: storing, by the plurality of RFID tags, at least a portion of the first signal from the second wireless communications device in respective memories; and determining, by the channel estimation unit, the channel estimation information based on the first signal stored in the respective memories.

Aspect 8 includes the method of any of aspects 1-7, further comprising estimating one or more weights for each of the one or more RIS elements.

Aspect 9 includes the method of any of aspects 1-8, wherein the second signal includes channel measurement data from each of the plurality of RFID tags for channel estimation by the second wireless communications device.

Aspect 10 includes the method of any of aspects 1-9, further comprising: receiving, by one or more of the plurality of RFID tags, a third signal including RIS configuration information from the second wireless communications device based on the channel measurement data.

Aspect 11 includes the method of any of aspects 1-10, wherein the RIS configuration information includes a beam index.

Aspect 12 includes the method of any of aspects 1-11, wherein the RIS configuration information includes a matrix comprising one or more weights for each of the one or more RIS elements determined based on interpolation or extrapolation from the measurement data from each of the plurality of RFID tags.

Aspect 13 includes the method of any of aspects 1-12, wherein the receiving the third signal includes: receiving a first portion of the matrix by a first subset of the plurality of the RFID tags; and receiving a second portion of the matrix by a second subset of the plurality of the RFID tags.

Aspect 14 includes the method of any of aspects 1-13, wherein the receiving the first signal further comprises receiving the first signal by each of the plurality of RFID tags.

Aspect 15 includes the method of any of aspects 1-14, wherein the receiving the first signal further comprises receiving the first signal by a subset of the plurality of RFID tags.

Aspect 16 includes the method of any of aspects 1-15, wherein the receiving the first signal further comprises: receiving a first portion of the first signal by a first subset of the plurality of RFID tags and a second portion of the first signal by a second subset of the plurality of RFID tags.

Aspect 17 includes the method of any of aspects 1-16, further comprising defining a common password for each of the plurality of RFID tags.

Aspect 18 includes the method of any of aspects 1-17, wherein the second wireless communications device is one of a base station (BS), a user equipment (UE), or a programmable logic controller (PLC).

Aspect 19 includes a method of wireless communication, comprising: transmitting a first signal by a first wireless communications device to a second wireless communications device, the second wireless communications device comprising: a reconfigurable intelligent surface (RIS) including an array of one or more RIS elements; a RIS controller; and a radio frequency identification (RFID) tag, the first signal being received by the RFID tag; and receiving, by the first wireless communications device from the second wireless communications device using backscatter communication, a second signal based on the first signal.

Aspect 20 includes the method of aspect 19, wherein the RIS controller comprises the RFID tag.

Aspect 21 includes the method of any of aspects 19-20, wherein the RFID tag comprises a plurality of RFID tags amongst the array of one or more RIS elements, the plurality of RFID tags in communication with the RIS controller.

Aspect 22 includes the method of any of aspects 19-21, wherein the transmitting the first signal further comprises transmitting the first signal to each of the plurality of RFID tags.

Aspect 23 includes the method of any of aspects 19-22, wherein the transmitting the first signal further comprises transmitting the first signal to a subset of the plurality of RFID tags.

Aspect 24 includes the method of any of aspects 19-23, wherein the transmitting the first signal further comprises: transmitting a first portion of the first signal to a first subset of the plurality of RFID tags and a second portion of the first signal to a second subset of the plurality of RFID tags.

Aspect 25 includes the method of any of aspects 19-24, further comprising defining a common password for each of the plurality of RFID tags.

Aspect 26 includes the method of any of aspects 19-25, wherein the first signal comprises a reference signal.

Aspect 27 includes the method of any of aspects 19-26, wherein the second signal includes channel measurement data from each of the plurality of RFID tags for channel estimation by the first wireless communications device.

Aspect 28 includes the method of any of aspects 19-27, wherein the second signal includes channel estimation information.

Aspect 29 includes the method of any of aspects 19-28, further comprising determining, by the first wireless communications device, channel estimation information.

Aspect 30 includes the method of any of aspects 19-29, further comprising estimating one or more weights for each of the one or more RIS elements.

Aspect 31 includes the method of any of aspects 19-30, further comprising: transmitting, by the first wireless communications device, a third signal including RIS configuration information to the second wireless communications device based on the one or more estimated weights.

Aspect 32 includes the method of any of aspects 19-31, wherein the RIS configuration information includes a beam index.

Aspect 33 includes the method of any of aspects 19-32, wherein the RIS configuration information includes a matrix comprising the one or more estimated weights for each of the one or more RIS elements determined based on interpolation or extrapolation from measurement data of the RFID tag.

Aspect 34 includes the method of any of aspects 19-33, wherein the RFID tag comprises a plurality of RFID tags and wherein the transmitting the third signal includes: transmitting a first portion of the matrix to a first subset of the plurality of the RFID tags; and transmitting a second portion of the matrix to a second subset of the plurality of the RFID tags.

Aspect 35 includes the method of any of aspects 19-34, wherein the first wireless communications device is one of a base station (BS), a user equipment (UE), or a programmable logic controller (PLC). Aspect 36 includes a wireless communications device, comprising: a reconfigurable intelligent surface (RIS) including an array of one or more RIS elements; a RIS controller; and a radio frequency identification (RFID) tag, the first signal being received by the RFID tag; and a processor, wherein the wireless communications device is configured to: receive, by the RFID tag, a first signal; and convey, by the RFID tag, a second signal using backscatter communication based on the first signal.

Aspect 37 includes the wireless communications device of aspect 36, wherein the RIS controller comprises the RFID tag.

Aspect 38 includes the wireless communications device of any of aspects 36-37, wherein the RFID tag comprises a plurality of RFID tags amongst the array of one or more RIS elements, the plurality of RFID tags in communication with the RIS controller.

Aspect 39 includes the wireless communications device of any of aspects 36-38, further configured to receive the first signal by each of the plurality of RFID tags.

Aspect 40 includes the wireless communications device of any of aspects 36-39, further configured to receive the first signal by a subset of the plurality of RFID tags.

Aspect 41 includes the wireless communications device of any of aspects 36-40, further configured to: receive a first portion of the first signal by a first subset of the plurality of RFID tags and a second portion of the first signal by a second subset of the plurality of RFID tags.

Aspect 42 includes the wireless communications device of any of aspects 36-41, further configured to define a common password for each of the plurality of RFID tags.

Aspect 43 includes the wireless communications device of any of aspects 36-42, wherein the first signal comprises a reference signal.

Aspect 44 includes the wireless communications device of any of aspects 36-43, wherein the second signal includes channel measurement data from each of the plurality of RFID tags for channel estimation.

Aspect 45 includes the wireless communications device of any of aspects 36-44, wherein the second signal includes channel estimation information.

Aspect 46 includes the wireless communications device of any of aspects 36-45, further configured to determine, by the plurality of RFID tags, the channel estimation information, and convey the second signal by the plurality of RFID tags.

Aspect 47 includes the wireless communications device of any of aspects 36-46, further comprising a channel estimation unit, wherein the wireless communications device is further configured to: store, by the plurality of RFID tags, at least a portion of the first signal from the second wireless communications device in respective memories; and determine, by the channel estimation unit, the channel estimation information based on the first signal stored in the respective memories.

Aspect 48 includes the wireless communications device of any of aspects 36-47, further configured to estimate one or more weights for each of the one or more RIS elements.

Aspect 49 includes the wireless communications device of any of aspects 36-48, further configured to: receive, by one or more of the plurality of RFID tags, a third signal including RIS configuration information based on the channel measurement data.

Aspect 50 includes the wireless communications device of any of aspects 36-49, wherein the RIS configuration information includes a beam index.

Aspect 51 includes the wireless communications device of any of aspects 36-50, wherein the RIS configuration information includes a matrix comprising one or more weights for each of the one or more RIS elements determined based on interpolation or extrapolation from the measurement data from each of the plurality of RFID tags.

Aspect 52 includes the wireless communications device of any of aspects 36-51, further configured to: receive a first portion of the matrix by a first subset of the plurality of the RFID tags; and receive a second portion of the matrix by a second subset of the plurality of the RFID tags.

Aspect 53 includes the wireless communications device of any of aspects 36-52, further configured to receive the first signal from one of a base station (BS), a user equipment (UE), or a programmable logic controller (PLC).

Aspect 54 includes a wireless communications device, comprising: a transceiver; and a processor coupled with the transceiver, wherein the wireless communications device is configured to: transmit a first signal to a reconfigurable intelligent surface (RIS), the RIS comprising: an array of one or more RIS elements; a RIS controller; and a radio frequency identification (RFID) tag, the first signal being received by the RFID tag; and receive from the RIS, a second signal based on the first signal.

Aspect 55 includes the wireless communications device of aspect 54, wherein the RIS controller comprises the RFID tag.

Aspect 56 includes the wireless communications device of any of aspects 54-55, wherein the RFID tag comprises a plurality of RFID tags amongst the array of one or more RIS elements, the plurality of RFID tags in communication with the RIS controller.

Aspect 57 includes the wireless communications device of any of aspects 54-56, further configured to transmit the first signal to each of the plurality of RFID tags.

Aspect 58 includes the wireless communications device of any of aspects 54-57, further configured to transmit the first signal to a subset of the plurality of RFID tags.

Aspect 59 includes the wireless communications device of any of aspects 54-58, further configured to transmit a first portion of the first signal to a first subset of the plurality of RFID tags and a second portion of the first signal to a second subset of the plurality of RFID tags.

Aspect 60 includes the wireless communications device of any of aspects 54-59, further configured to define a common password for each of the plurality of RFID tags.

Aspect 61 includes the wireless communications device of any of aspects 54-60, wherein the first signal comprises a reference signal.

Aspect 62 includes the wireless communications device of any of aspects 54-61, wherein the second signal includes channel measurement data from each of the plurality of RFID tags for channel estimation by the wireless communications device.

Aspect 63 includes the wireless communications device of any of aspects 54-62, wherein the second signal includes channel estimation information.

Aspect 64 includes the wireless communications device of any of aspects 54-63, further configured to determine channel estimation information.

Aspect 65 includes the wireless communications device of any of aspects 54-64, further configured to estimate one or more weights for each of the one or more RIS elements.

Aspect 66 includes the wireless communications device of any of aspects 54-65, further configured to: transmit a third signal including RIS configuration information to the RIS based on the one or more estimated weights.

Aspect 67 includes the wireless communications device of any of aspects 54-66, wherein the RIS configuration information includes a beam index.

Aspect 68 includes the wireless communications device of any of aspects 54-67, wherein the RIS configuration information includes a matrix comprising the one or more estimated weights for each of the one or more RIS elements determined based on interpolation or extrapolation from measurement data of the RFID tag.

Aspect 69 includes the wireless communications device of any of aspects 54-68, wherein the RFID tag comprises a plurality of RFID tags and wherein the wireless communications device is further configured to: transmit a first portion of the matrix to a first subset of the plurality of the RFID tags; and transmit a second portion of the matrix to a second subset of the plurality of the RFID tags.

Aspect 70 includes the wireless communications device of any of aspects 54-69, wherein the wireless communications device is one of a base station (BS), a user equipment (UE), or a programmable logic controller (PLC).

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication, comprising:
receiving a first signal by a first wireless communications device from a second wireless communications device, the first wireless communications device further comprising:
a reconfigurable intelligent surface (RIS) including an array of one or more RIS elements;
a RIS controller; and
a radio frequency identification (RFID) tag, the first signal being received by the RFID tag; and
conveying, by the RFID tag of the first wireless communications device to the second wireless communications device, a second signal using backscatter communication based on the first signal.

2. The method of claim 1, wherein the RIS controller comprises the RFID tag.

3. The method of claim 1, wherein the RFID tag comprises a plurality of RFID tags amongst the array of one or more RIS elements, the plurality of RFID tags in communication with the RIS controller.

4. The method of claim 3, wherein the receiving the first signal further comprises receiving the first signal by the plurality of RFID tags.

5. The method of claim 3, wherein the receiving the first signal further comprises:
receiving a first portion of the first signal by a first subset of the plurality of RFID tags and a second portion of the first signal by a second subset of the plurality of RFID tags.

6. The method of claim 3, wherein the second signal includes channel measurement data from each of the plurality of RFID tags for channel estimation by the second wireless communications device.

7. The method of claim 3, wherein the second signal includes channel estimation information.

8. The method of claim 7, wherein the first wireless communications device further comprises a channel estimation unit, the method further comprising:
storing, by the plurality of RFID tags, at least a portion of the first signal from the second wireless communications device in respective memories; and
determining, by the channel estimation unit, the channel estimation information based on the first signal stored in the respective memories.

9. The method of claim 8, further comprising:
receiving, by one or more of the plurality of RFID tags, a third signal including RIS configuration information from the second wireless communications device based on the channel measurement data, wherein the RIS configuration information includes a matrix comprising one or more weights for each of the one or more RIS elements determined based on interpolation or extrapolation from the measurement data from each of the plurality of RFID tags.

10. A method of wireless communication, comprising:
transmitting a first signal by a first wireless communications device to a second wireless communications device, the second wireless communications device comprising:
a reconfigurable intelligent surface (RIS) including an array of one or more RIS elements;
a RIS controller; and
a radio frequency identification (RFID) tag, the first signal being received by the RFID tag; and
receiving, by the first wireless communications device from the second wireless communications device using backscatter communication, a second signal based on the first signal.

11. The method of claim 10, wherein the RIS controller comprises the RFID tag.

12. The method of claim 10, wherein the RFID tag comprises a plurality of RFID tags amongst the array of one or more RIS elements, the plurality of RFID tags in communication with the RIS controller.

13. The method of claim 12, wherein the transmitting the first signal further comprises:
transmitting a first portion of the first signal to a first subset of the plurality of RFID tags and a second portion of the first signal to a second subset of the plurality of RFID tags.

14. The method of claim 12, further comprising defining a common password for each of the plurality of RFID tags.

15. The method of claim 10, further comprising determining, by the first wireless communications device, channel estimation information.

16. The method of claim 15, further comprising:
transmitting, by the first wireless communications device, a third signal including RIS configuration information to the second wireless communications device based on the one or more estimated weights.

17. The method of claim 16, wherein the RFID tag comprises a plurality of RFID tags and wherein the transmitting the third signal includes:
transmitting a first portion of the RIS configuration information to a first subset of the plurality of the RFID tags; and
transmitting a second portion of the RIS configuration information to a second subset of the plurality of the RFID tags.

18. A wireless communications device, comprising:
a reconfigurable intelligent surface (RIS) including an array of one or more RIS elements;
a RIS controller;
a radio frequency identification (RFID) tag, the first signal being received by the RFID tag; and
a processor, wherein the wireless communications device is configured to:
receive, by the RFID tag, a first signal; and
convey, by the RFID tag, a second signal using backscatter communication based on the first signal.

19. The wireless communications device of claim 18, wherein the RFID tag comprises a plurality of RFID tags amongst the array of one or more RIS elements, the plurality of RFID tags in communication with the RIS controller.

20. The wireless communications device of claim 19, further configured to receive the first signal by the plurality of RFID tags.

21. The wireless communications device of claim 19, further configured to define a common password for each of the plurality of RFID tags.

22. The wireless communications device of claim 19, wherein the second signal includes channel measurement data from each of the plurality of RFID tags for channel estimation.

23. The wireless communications device of claim 19, wherein the second signal includes channel estimation information and wherein the wireless communications device is further configured to determine, by the plurality of RFID tags, the channel estimation information, and convey the second signal by the plurality of RFID tags.

24. The wireless communications device of claim 23, further configured to:
receive, by one or more of the plurality of RFID tags, a third signal including RIS configuration information based on the channel measurement data.

25. A wireless communications device, comprising:
a transceiver; and
a processor coupled with the transceiver, wherein the wireless communications device is configured to:
transmit a first signal to a reconfigurable intelligent surface (RIS), the RIS comprising:
an array of one or more RIS elements;
a RIS controller; and
a radio frequency identification (RFID) tag, the first signal being received by the RFID tag; and
receive from the RIS, a second signal based on the first signal.

26. The wireless communications device of claim 25, wherein the RFID tag comprises a plurality of RFID tags amongst the array of one or more RIS elements, the plurality of RFID tags in communication with the RIS controller, and wherein the wireless communications device is further configured to transmit the first signal to the plurality of RFID tags.

27. The wireless communications device of claim 26, wherein the first signal comprises a reference signal.

28. The wireless communications device of claim 27, wherein the second signal includes channel estimation information.

29. The wireless communications device of claim 25, further configured to determine channel estimation information, the channel estimation information including one or more weights for each of the one or more RIS elements.

30. The wireless communications device of claim 29, further configured to:
transmit a third signal including RIS configuration information to the RIS based on the one or more estimated weights.
